(19) United States
(12) Patent Application Publication
(10) Pub. No.: US 2020/0018063 A1
(43) Pub. Date: Jan. 16, 2020

(54) FIRE SHIELD CONNECTOR

(71) Applicant: Dennis LeBlang, Desert Hot Springs, CA (US)

(72) Inventor: Dennis LeBlang, Desert Hot Springs, CA (US)

(21) Appl. No.: 16/439,640

(22) Filed: Jun. 12, 2019

Related U.S. Application Data
(63) Continuation-in-part of application No. 16/406,249, filed on May 8, 2019.
Application No. 16/406,249 is a continuation-in-part of application No. 16/406,289, filed on May 8, 2019.
Application No. 16/406,289 is a continuation-in-part of application No. 16/396,624, filed on Apr. 26, 2019.
Application No. 16/396,624 is a continuation-in-part of application No. 16/354,081, filed on Mar. 14, 2019.
Application No. 16/354,081 is a continuation-in-part of application No. 16/198,831, filed on Nov. 22, 2018.
Application No. 16/198,831 is a continuation-in-part of application No. 16/195,847, filed on Nov. 19, 2018, now abandoned.
Application No. 16/195,847 is a continuation-in-part of application No. 15/724,137, filed on Oct. 3, 2017, now Pat. No. 10,422,136.
Application No. 15/724,137 is a continuation-in-part of application No. 15/449,250, filed on Mar. 3, 2017, now abandoned.
Application No. 15/449,250 is a continuation-in-part of application No. 15/430,781, filed on Feb. 13, 2017.
Application No. 15/430,781 is a continuation-in-part of application No. 15/295,172, filed on Oct. 17, 2016, now Pat. No. 10,364,566.
Application No. 15/295,172 is a continuation-in-part of application No. 15/090,460, filed on Apr. 4, 2016.
Application No. 15/090,460 is a continuation-in-part of application No. 14/946,378, filed on Nov. 19, 2015.
Application No. 14/946,378 is a continuation-in-part of application No. 13/398,243, filed on Feb. 16, 2012, now abandoned.
Application No. 13/398,243 is a continuation-in-part of application No. 12/456,707, filed on Jun. 22, 2009, now Pat. No. 8,161,699.
Application No. 12/456,707 is a continuation-in-part of application No. 12/231,875, filed on Sep. 8, 2008, now Pat. No. 8,176,696.
(60) Provisional application No. 62/533,092, filed on Jul. 16, 2017.
(60) Provisional application No. 62/490,917, filed on Apr. 27, 2017.
(60) Provisional application No. 62/485,114, filed on Apr. 13, 2017.
(60) Provisional application No. 62/399,434, filed on Sep. 25, 2016.
(60) Provisional application No. 62/385,932, filed on Sep. 9, 2016.
(60) Provisional application No. 62/378,615, filed on Aug. 23, 2016.
(60) Provisional application No. 62/345,153, filed on Jun. 3, 2016.
(60) Provisional application No. 62/308,520, filed on Mar. 15, 2016.
(60) Provisional application No. 62/298,762, filed on Feb. 23, 2016.
(60) Provisional application No. 62/294,756, filed on Feb. 12, 2016.
(60) Provisional application No. 62/274,134, filed on Dec. 31, 2015.
(60) Provisional application No. 62/264,033, filed on Dec. 7, 2015.
(60) Provisional application No. 62/170,269, filed on Jun. 3, 2015.
(60) Provisional application No. 62/143,097, filed on Apr. 4, 2015.
(60) Provisional application No. 62/139,916, filed on Mar. 30, 2015.
(60) Provisional application No. 62/083,276, filed on Nov. 23, 2014.
(60) Provisional application No. 61/629,552, filed on Nov. 22, 2011.
(60) Provisional application No. 61/628,044, filed on Oct. 24, 2011.

(51) Int. Cl. E04B 1/94; F16B 7/22

(52) U.S. Cl. CPC E04B 1/947; F16B 7/22

(57) ABSTRACT

The present invention relates to a building construction using a fire protection shield connector within a wall cavity formed by fire protection boards connected to metal framing members together using the fire shield connector as a shield between the fire protection boards and the metal framing members with the fire shield connector ends securing adjacent metal framing members together by interlocking the fire shield connector ends to adjacent fire shield connectors ends and where the fire shield connector end has an extension cover securing the hole opening in the metal framing member and securing the opposing connector end by overlapping the adjacent fire protection shield connector forming a tight fit within the wall cavity.

This application is a a continuous-in-part pending application U.S. Ser. No. 15/449,250 filed Mar. 3, 2017 and this application claims priority to the following: continuous-in-part pending application U.S. Ser. No. 16/406,289 filed May 8, 2019 and; continuous-in-part pending application U.S. Ser. No. 16/396,624 filed Apr. 26, 2019 and; continuous-in-part pending application U.S. Ser. No. 16/354,081 filed Mar. 14, 2019 and; continuous-in-part pending application U.S. Ser. No. 16/198,831 filed Nov. 22, 2018 and; continuous-in-part pending application U.S. Ser. No. 16/195,847 filed Nov. 19, 2018 and; continuation-in-part pending application U.S. Ser. No. 15/724,137 filed Nov. 3, 2017 that included provisional application U.S. 62/533,092 filed Jul. 16, 2017 (now expired) and; provisional application U.S. 62/490,917 filed Apr. 27, 2017 (now expired) and provisional application U.S. 62/485,114 filed Apr. 13, 2017 (now expired) and continuous-in-part pending application U.S. Ser. No. 15/430,781 filed Feb. 13, 2017 that included provisional application U.S. 62/264,033 filed Jul. 15, 2015 (now expired) and provisional application U.S. 62/274,134 filed Dec. 31, 2015 (now expired) and provisional application U.S. 62/294,756 filed Feb. 12, 2016 (now expired) and provisional application U.S. 62/298,782 filed Feb. 23, 2016 (now expired) and provisional application U.S. 62/308,520 filed Mar. 15, 2016 (now expired) and provisional application U.S. 62/345,153 filed Jun. 3, 2015 (now expired) and provisional application U.S. 62/385,932 filed Sep. 9, 2016 (now expired) and provisional application U.S. 62/339,434 filed Sep. 15, 2016 (now expired) and; continuation-in-part pending application U.S. Ser. No. 15/295,172 dated Oct. 17, 2016 that included provisional application U.S. 62/242,705 filed Oct. 16, 2015 (now expired) and provisional application U.S. 62/244,135 filed Oct. 20, 2015 (now expired) and provisional application U.S. 62/264,033 filed Dec. 7, 2015 (now expired) and provisional application U.S. 62/274,134 filed Dec. 15, 2015 (now expired) and provisional application U.S. 62/345,153 filed Mar. 6, 2016 (now expired) and; continuous-in-part of pending application U.S. Ser. No. 15/090,460 filed Nov. 19, 2015 that included provisional application U.S. 62/143,097 filed Apr. 4, 2015 (now expired) and provisional application U.S. 62/208,766 filed Aug. 23, 2015 (now expired) and provisional application U.S. 62/242,705 filed Nov. 16, 2015 (now expired) and; continuous-in-part of pending application U.S. Ser. No. 14/946,378 filed Mar. 3, 2015 and provisional application U.S. 62/083,276 filed Nov. 23, 2014 (now expired) and provisional application U.S. 62/139,913 filed Mar. 30, 2015 (now expired) and provisional application U.S. 62/170,269 filed Jun. 15, 2015 (now expired) and; continuous-in-part pending application U.S. Ser. No. 15/449,250 filed Mar. 3, 2017 that included provisional application U.S. 61/629,044 filed Nov. 24, 2011 (now expired) and provisional application U.S. 61/629,552 filed Nov. 22, 2011 (now expired) and provisional application U.S. 61/001,566 filed May 21, 2014 (now expired) and provisional application U.S. 62/170,269 filed Jul. 30, 2016 (now expired) and continuous-in-part pending application U.S. Ser. No. 12/231,875 filed Sep. 8, 2008, now U.S. Pat. No. 8,176,696 issued May 15, 2012 and continuous-in-part pending application U.S. Ser. No. 12/456,707 filed Jun. 22, 2009, now U.S. Pat. No. 8,161,707 issued Aug. 12, 2014 and the disclosures of the above cited US Patent Applications and US Provisional Applications of the Applicant, including all drawings and all the specifications, are hereby incorporated by reference in their entireties into this US Patent Application.

### FEDERALLY SPONSORED RESEARCH OR DEVELOPMENT

Not applicable

### PARTIES OR JOINT RESEARCH

Not applicable

### FIELD OF THE INVENTION

The present invention relates to integrating the structural integrity of the spacing-bracing connectors into also be a fire shield connectors using spacing-bracing members as the fire stops with self-locking connection means between intersecting metal framing members where the variable shape configurations of the web or flanges of the spacing-bracing member and the support members form a fire chamber between the wall boards (not included) attached to the flanges of support members. The fire shield connectors connect adjacent metal framing members together through the holes of the metal framing members and then seal the holes creating a structural fire shield connector between the metal framing members and the fire chambers. The spacing-bracing members have different end connections that connect through the holes of the metal framing members such as using two web-flange notches at each web or a continuous web flange notch with the web being a continuous notch extending into each web that connects to support members and crossing members. Different extensions can connect to the support member by using the notches and tabs to secure hook fingers, hook tongues and hook receivers to secure the crossing members together forming the self-locking connections. The spacing-bracing members are configured to occupy the fire chamber between the flanges of the support member as well as the hole in the web of the support members. Sometimes a flat plate is incorporated as part of the spacing-bracing member referred to as an extension cover or by having the flat plate installed after the spacing-brace member is installed between support members by using the hook receivers. In other fire shield connectors the web extension becomes the extension cover that closed the holes in the support members. Other types of connections are also used including the L-shaped brackets and the W-shaped clips.

### BACKGROUND OF THE INVENTION

Light gauge metal framing have been used in the construction of buildings for many years, however due to the C shape of the vertical support members sealing off the air space or air chambers that exists between support members have always been difficult to obtain. The sealing of the air space between support members helps prevent a fire from spreading too fast between the wall surface on one side of the wall to the wall surface on the other side of the wall. Nogging is a term used in Europe and Australia where a horizontal bracing member has a punch-out hole large enough for the entire metal support framing member to fit into, but still leaving a large hole the size and shape of the inside area of the C channel usually used as for metal framing member.

Nogging still leaves an opening in the horizontal bracing member that a fire will spread between the top and bottom surface of the horizontal bracing member that requires several people to install the Nogging member and requires fasteners to be connected to the flanges of the metal framing members.

### DESCRIPTION OF PRIOR ART

As previously stated Nogging seems to be the most used solution to solve the problems of forming two different fire chambers formed between the support members and a horizontal spacing-bracing member. Other companies have the horizontal bracing channels with tabs extending at the longitudinal ends of the horizontal bracing channels which still require fasteners into the web of the metal framing members.

### SUMMARY OF THE INVENTION

The present invention shows many different configurations of spacing-bracing connectors that connect adjacent spacing-bracing connectors together and different types of connections between metal framing members and the spacing-bracing connectors. The patent application shows many different types of connectors that stop a fire from spreading within a wall framing structure that is between metal framing members and between spacing-bracing members that connect the metal framing members together. These various connections create smaller air spaces between the metal framing various system components and this patent application discloses how to connect spacing-bracing members to adjacent metal framing members to seal the various air spaces fire chambers to reduce the spread of a fire within a wall framing system.

The metal framing building components between metal framing members are typically shown as a U shaped channel having a web, flanges. When lips and/or double lip edges are added the connector is then referred to as a reverse lip spacer brace. The lips extend from the flanges to seal the fire chambers between fire composite boards like drywall. The spacer braces can have bent flanges, W shape flanges, web notches, web-flange notches, two half notches or ½ notches, web-flange notches, lip notches, upward oriented flanges or downward oriented flanges, overlapping webs, flanges and lips, flanges having sloped flanges, hook tongues connected to hook receivers or receiver holes, flanges being slightly canted where the entire connector is installed in a notch or only an element of the connectors is in the notch. No matter what the shape of the connector, a smaller connector can fit into a larger connector where the connector notches secure the metal framing members. The connector also uses hook tongues and hook receivers.to secure adjacent spacing-bracing connectors and where the connectors also use hole notches, hole protrusions, at the metal framing member. Connectors secure the metal framing members, but are connected end to end by adjacent spacing-bracing members and where the spacing-bracing members have attached extension covers extending from the spacing-bracing connectors. The extension covers can be attached as smaller segments and referred to as brackets. The brackets are slightly larger or smaller in width depending on how the brackets are being installed and typically are installed between the lips, flanges and web of the support member and having the extension cover as part of the bracket component. The extension covers can be just a flat plate installed as a separate component, but are an integral component of fire shields the seal the air spaces between metal framing construction components.

In addition the spacing-bracing members have different variations where a flat plate is used as a fire stop to seal the web hole from adjacent metal framing support members. A web hole has extensions or hole protrusions that extend from the edges of the hole in the metal framing member. The hole protrusions are shown here as a means of securing a spacing-bracing member by using a notch-tab profile or as a filler to fill a void in the spacing-bracing connector shown typically at the underside of a spacing-bracing connector. Other hole protrusions are shown with notches or used as a brace to secure the spacing-bracing member to prevent vertical movement . . . . The hole protrusions or lip notches at the side edge of the hole at the support member stabilize the spacing-bracing members from moving vertically and horizontally and when the hole in the web of the metal framing member is sealed provides a stable solution against movement.

The fire shield connector always fills the full width of a wall cavity that is from the inside surface of a fire protection board like drywall to the opposing interior side of the drywall to the vertical separation of a metal framing member like the web of the support member to the sealing of the hole within the metal framing member plus a connection means between the fire shield member where the connection means typically occurs through the hole of the support member. The various connections are easy to install and manufacture versus the existing traditional method of forming fire stops within metal framing support. In addition the spacing-bracing members can be pivoted horizontally and vertically altering the shape of the spacing-bracing member where additional fire resistance insulation materials can be installed to prevent the spread of any fire . . . .

### BRIEF DESCRIPTION OF THE DRAWINGS

FIG. 1 is similar to FIG. 2 except the flanges do not overlap the support member, but only are aligned with the flanges of the support member. The left U shaped spacer brace is shown with the web logged into the hole notch with the flange and the hook finger securing the connector to the web of the support member.

FIG. 2 shows a horizontal bracing member having extension with a hook finger and the opposing end having a hook tongue with the extension overlapping an adjacent horizontal bracing member connected to the receiver slot hole, but having and extending flanges that overlap the flanges of the support member.

FIG. 3 shows an enlargement of the spacing-bracing member.

FIG. 4 shows the spacing-bracing member with the fire shield plate connected to the horizontal bracing member similar to FIG. 1.

FIG. 5 shows an enlargement of the bracket used in FIG. 6.

FIG. 6 shows a similar spacing-bracing member configuration as FIG. 4 however the hook tongue is configured differently than previously shown.

FIG. 7 shows an elevation of the hole in the support member with some of the various hole edge configurations and locations of the hole notches. The inside edges of the hole can vary in shape and location depending on the shape of the spacer brace and where the hole notches in the protrusion are located. The protrusions and notches accomplish the same function as they both keep the spacer brace lodged in the hole notches or the side or bottom edges of the hole. The protrusions at the top edges show hole notches that can secure the spacing-bracing member to the support member.

FIG. 8 shows an upward oriented U shaped spacer brace with notches at the web and flanges that engage the hole side edges and an adjacent spacer brace with an upward oriented tongue at the hook tongue to engage the flat plate that is fastened to the support member.

FIG. 9 shows an upward oriented U shaped spacer brace with the right end having an upward oriented hook receiver with the flat plate where the flanges and flat plate secure the U shape shaper brace to the web of the support member with the opposing end having a hook tongue also fitting into the hook receiver.

FIG. 10 shows an upward oriented reverse lip shaped spacer brace with notches in the lips for ½ hole engagement with notches at the flanges for a flat plate to be installed in the flange notches for an adjacent reverse lip spacer brace to abut the flat plate and where the hook tongue can extend into receiver slot hole of the first reverse lip spacer brace.

FIG. 11 shows a downward oriented U shape spacer brace with the flanges and web being indented at the hole and the web extending over the hole bottom edge with the opposing end of an identical U shaped spacer brace having the flanges and web being indented at the hole, however the web extension has a hook tongue extending upward that overlaps the first U shaped spacer brace for connecting a bracing plate to the support member.

FIG. 12 shows downward U shaped spacer brace with notches in flanges engage hole bottom edge with an identical U shaped spacer brace having the opposing end having an indentation at flanges and web with web extension having a hook tongue overlap the web of the first U shaped spacer brace extending downward into the receiver slot hole.

FIG. 13 is a multi-plane one piece bracket having an L shape where the bracket has a horizontal leg with notches that engage the lips of the support member vertical leg with the vertical leg engaging the opposite side of the hole in the support member.

FIG. 14 shows a bracket at the intersection at the hole in the support member with a hook tongue having the tongue end extend through the hole and bracket except a vertical side is extended past the hole allowing a vertical plate to fit between the vertical side and the web of the support member forming a two piece bracket assembly.

FIG. 15 shows an L-shaped bracket having extended tabs in the web engage tab holes of the horizontal bracing channel and the web extends the full width of the opening with the web ends having ½ notch that engage the lips of the support member and the web having a vertical leg with the vertical leg being the other half of the ½ notch with the vertical leg wrap around the flanges for additional support.

FIG. 16 shows an L-shaped bracket similar to FIG. 15 except here the extension spans across the hole in the metal member rather than the lips and flanges of the metal framing member and the intersection of the web and flange have a bulge with the bulge extending over the lower channel also having a bulge where the upper bulges engage the lower bulges to secure the U shape spacer brace to the U shape channel.

FIG. 17 shows two adjacent upward oriented U shaped spacer braces connecting to a support member with the web of the longitudinal end having flange notches connected to the underside of a hole protrusion with the opposing end having a web extension with a hook tongue for insertion into a receiving hole in the web of the adjacent spacer brace along with 2 diagonal oriented U shaped spacer braces framing where the hook finger end connection has an extension that engages the hole top edge at the hole notch while the lower diagonal orie60ed U shaped spacer brace has a notch tab end connection that engages the hole side edges.

FIG. 18 shows an upward oriented reverse lip brace with one end having a web extension having a width wider than the hole with web notches at the end of the web extensions with the notches engaging the hole side edges of the adjacent support member with an adjacent spacer brace to fit over the web extension to engage the support member at the lip notches.

FIG. 19 shows an upward oriented U shaped space brace with flange notches for a flat plate to be secured to the support channels and the web having a slot receiver hole for an adjacent spacer brace with a downward hook shape engage the slot hole of the first spacer brace.

FIG. 20 shows two spacer braces intersecting at hole in the metal framing member where one end has the extension engaged in the hole with the finger extending over the bottom edge with the opposite end of an adjacent spacer brace having a notched-tab end to engage the tongue of the hook tongue into the slot hole at the web of the first U shaped spacer braces.

FIG. 21 shows a horizontally oriented downward facing U shaped spacer brace with a hook receiver passing through the hole of the support member for an adjacent U shaped spacer brace with a downward L-shaped hook tongue to fit into.

FIG. 22 shows the bracing member as U shaped facing upwards with notches in the side edges for the one piece bracket having a flat plate extending into the notches and attach to the web of the support member.

FIG. 23 shows the U shaped bracing member facing upwards with the first piece of the two piece bracket shown as a U shape facing upwards fitting between the side edges of the bracing member and the side edges of the first piece having notches for the second piece a flat plate to fit into the notches and being fasten together at the bottom sides of the bracing member and the web of the support member.

FIG. 24 shows the same configuration as FIG. 23 except the flat plate extends between the side edges and bottom side of the first piece of the two piece bracket.

FIG. 25 is an enlargement of FIG. 24 except a grommet has been added that fills an area between the bottom of the flat plate, the two side edges and the bottom side of the first and second piece of the two piece bracket.

FIG. 26 shows a bracing member having a reverse lip shape and downward facing over the horizontal tongue of the spacer block installed between the webs of the support members with a one piece bracket shown as a vertical plate connecting to a continuous groove at the web and partially into the side flanges and connected to the support member.

FIG. 27 shows two reverse lip spacer braces overlapping the hole bottom edge with a continuous web flange notch allowing the first reverse lip spacer brace to extend lower into the continuous web flange notch an adjacent spacer brace to overlap the first reverse lip spacer brace or using an alternate solution of having the hook tongue extend into a receiver slot hole. The overlapping reverse lip spacer brace will have a narrower web with longer flanges and lips for connection to the same hole in the support member.

FIG. 28 shows the W-shaped clip having hook receivers on both sides of the hole or top edge of the support member at the web. The W shaped clip can fit under hole notches for a more secure connection.

FIG. 29 shows a full width reverse lip spacer brace used as a fire shield having hole notches for the extension to fit into and a separate fire shield to extend over the hole in the support member.

FIG. 30 shows an enlargement of the bracket covering the hole in the support member and the area within the area within the inside perimeter of the C channel support member.

FIGS. 31-33 shows an elevation, enlargement and section of metal framing having the shape of the spacer braces are U-shape with bent flanges with flange notches in the longitudinal ends and having different widths when overlapping each other. Lips with notches can be installed at the longitudinal ends of flanges. The upper spacer brace has a web aperture for the tongue of the lower spacer brace to fit into. A protrusion is shown extending from the aperture side edges of the metal support member overlapping the upper spacer brace at the web. The spacer braces are installed with the wider longitudinal end being installed over the lower narrower width longitudinal end.

FIGS. 34-36 shows an elevation, enlargement and section of metal framing the reverse lip spacer brace has a reverse lip bracket with its flanges fitting over the overlapping connection and still having the notches of the bracket engaging the metal framing support.

FIGS. 37-39 shows an elevation, enlargement and section of metal framing uses a U shape spacer brace with flange notches having a T-shape rather than the L-shape previously described as the aperture has ledges that can be turned to face either direction therefore the T-shape notches has more flexibility when being installed.

FIGS. 40 & 41 shows an elevation and enlargement of metal framing where the two U shape spacer braces overlap each other with the flanges extending upward away from the web and where the flange notches extending into protrusions extending from the aperture at the metal framing supports with the flange notches engaging the underside of the protrusions. FIG. 42 appear the same, however the U shape spacer brace has the flanges extending into the bottom edge of the aperture in the metal framing supports and the flange notches have an additional horizontal notch where the horizontal notch extends into the ledges of the aperture in the metal framing support. In addition, protrusions extend from the hole side edges securing the U shaped spacer braces from moving vertically.

FIGS. 43-45 shows an elevation, enlargement and section of metal framing shows a W-shape spacer brace where the end of the flanges have a flange notch and where the flange notches extend into the bottom edge of ledges protruding from the hole side edges and where the spacer braces being of different widths to overlap and fit into adjacent W-shape spacer braces. On the other 49 hand a reverse lip spacer brace can be used as the lower spacer brace fitting into the side edges of the metal framing support side edges with the W-shape clip fitting into the bottom edge of the ledges extending from the aperture of the metal framing support.

FIGS. 46-48 shows an elevation, enlargement and section of metal framing having a combination of several spacer braces as the shape is similar to a reverse lip spacer brace having bent flanges and where the flanges and the web have an acute angle that penetrates the aperture side edges with a hole notch and where the aperture side edges and the aperture bottom edge have another notch for the lip notches to extend into while the upper reverse lip spacer brace uses only the lip notches to engage the aperture side edges and the lower spacer brace has the extended web with an upward extending tongue to engage the opposing end of the adjacent spacer brace having a hole receiver in the web for the lower tongue to fit into.

FIGS. 49 & 50 both show a section through the fire shield connector. FIG. 49 shows the wall section to include the fire protection board that is attached to the metal support members where the reverse lip support members have been previously shown connected to the holes in the support members. FIG. 49 shows the reverse lip spacer brace installed over the larger width protruding end of the reverse lip spacer brace being overlapped with the extension cover bent into a vertical position covering the hole in the support member.

FIG. 50 show the same hole, but with the lips removed and where the extension is wider allowing for the reverse lip spacer brace to fit into and where the extension has a hook tongue extending upward for the opposing end to having a receiver slot hole to fit into.

FIG. 51 shows an isometric view of a reverse lip spacer brace with a receiving slot hole in the web having an extension cover at the left end and an enlarger opposing end without lips and having a hook tab extending upward at the opposing end.

FIG. 52 shows an exploded view of FIGS. 49-51 where the left view shows the reverse lip spacer brace extended through the hole with a full view of the reverse lip spacer brace and the furthest right view shows the left end of the reverse lip spacer brace with the hook tongue ready to be installed into receiving slot hole at the web in the adjacent reverse lip spacer brace.

FIG. 53 shows the bulge having a bulge notch where the side edge hole fits into and the lip of the space brace fits into the hole notch of the web in the support member.

FIG. 54 is an isometric view where the notch and notch gap are shown in the flange of the U shaped spacer brace having the dorsal side facing upward with the flanges extending downward from the web.

FIG. 55 shows ledges installed in the web at the top plate of the support member, the bottom edge of the hole and punch-out tabs at the bottom edge of the support member for the flange gaps with flange notches can connect to the ledges or tabs to secure the horizontal and vertical metal framing members together.

### DESCRIPTION OF THE PREFERRED EMBODIMENTS

Various shapes of horizontal spacing-bracing members are shown throughout the application having different means to connecting a spacing-bracing member or several spacing-bracing members together to adjacent metal support members as well as various means to close the hole in the support member to create a fire stop between the spacing-bracing chambers and the support members

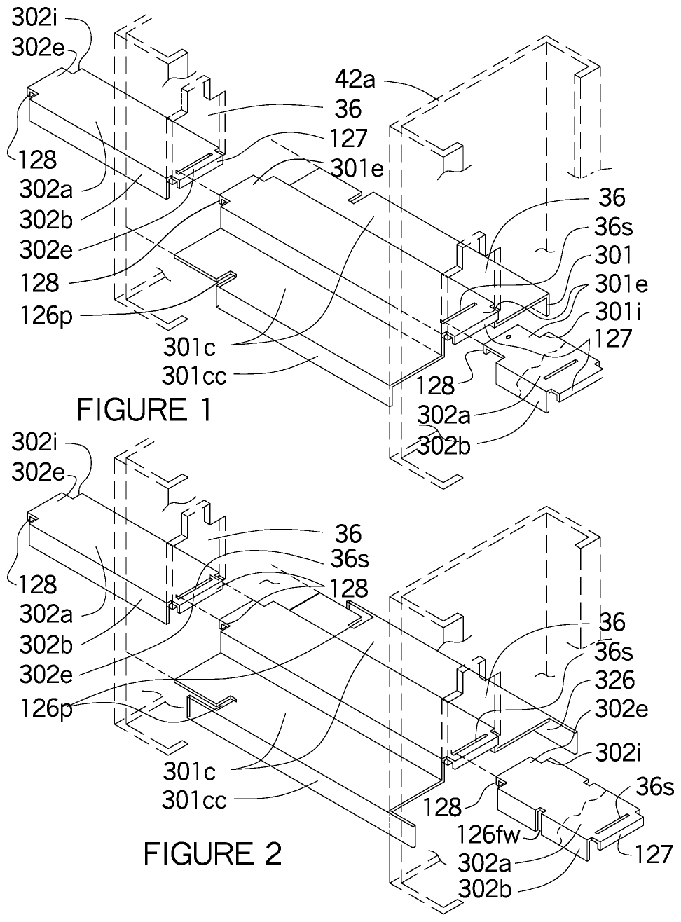

FIG. 1 shows a fire shield connector that has a full width spacing-bracing member and described as a reverse lip spacer brace 301 that spans between adjacent metal framing supports shown as a C channel having a web 42a with holes 36 connected longitudinally by flanges 42b at the flanges 42b connected to the lips 42c. The reverse lip spacer brace 301 has a web 301a with receiver slot holes 129s that spans between the adjacent support framing members with the web 301 having an extension 301e and a connection means to the support framing members. The web 301a has longitudinal flanges 301 connecting to the web 301a with lips 301c connected to the longitudinal flanges 301b. The lips 301c can have additional lips shown as 301cc extending from the lips 301c where the width of the reverse lip spacer brace 301 has the lips 301c on both sides of the flanges 301b align to the width of the web 42a of the metal framing support. The double width of the lips can align with the flange 42b of the metal framing support or can extend over the flange 42a for additional connection means to the metal framing supports. Since the metal framing members have lips 42c the lips 301c from the reverse lip spacer brace 301 require lip notches 126p indented from the lip 301c edges and not requiring the double lips 301cc at the flanges 42b of the metal framing members. The first end of the web 301a has an extension 301e pass through the hole 36 of the metal framing member with a hook finger 127 extending over the hole bottom edge 36be of the hole 36. The opposing end has a connection means of the web 301a passing through the hole 36 of the opposing web 42a of the adjacent metal framing member, however extending over an existing spacing-bracing member occupied at the same hole 36 for the extension 301e at the second end to have the hook tongue 128 with a tongue 128t extend into the receiver slot hole 129sh of the existing spacing-bracing member already occupied to the hole 36 in the metal framing member. The reverse lip spacer brace 301 has the web 301a engaged under the hole notches where the flanges 301b and the hook finger 127 secure the reverse lip spacer brace 301 into the hole 36 in the metal framing support. Other types of securing options are shown as a hole protrusions, web-flange notches, i.e. that will secure the reverse lip spacer brace 301 to the hole in the metal framing support.

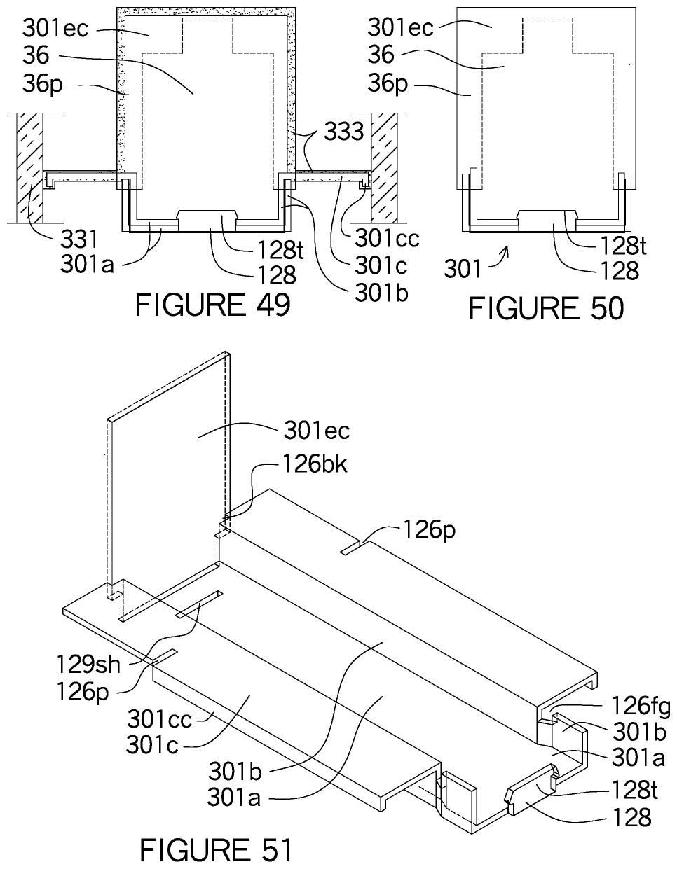

FIG. 2 shows the same configuration as a U shaped spacer brace 302 shown in FIG. 1 at both ends, however the middle U shaped spacer brace 302 is shown as a reverse lip spacer brace 301 having a web 301a with flanges 301b and lips 301c extending from the flanges 301b and double lips 301cc extending from the lips 301c, The double lips 301cc are shown extending the flanges 42b of the metal framing members The double lips 301cc are optional as well as any fire rated composite that is shown in FIG. 49 that lines the edges at 301b or lips 301c. The double lips 301cc are shown overlapping the flanges 42b of the metal framing member.

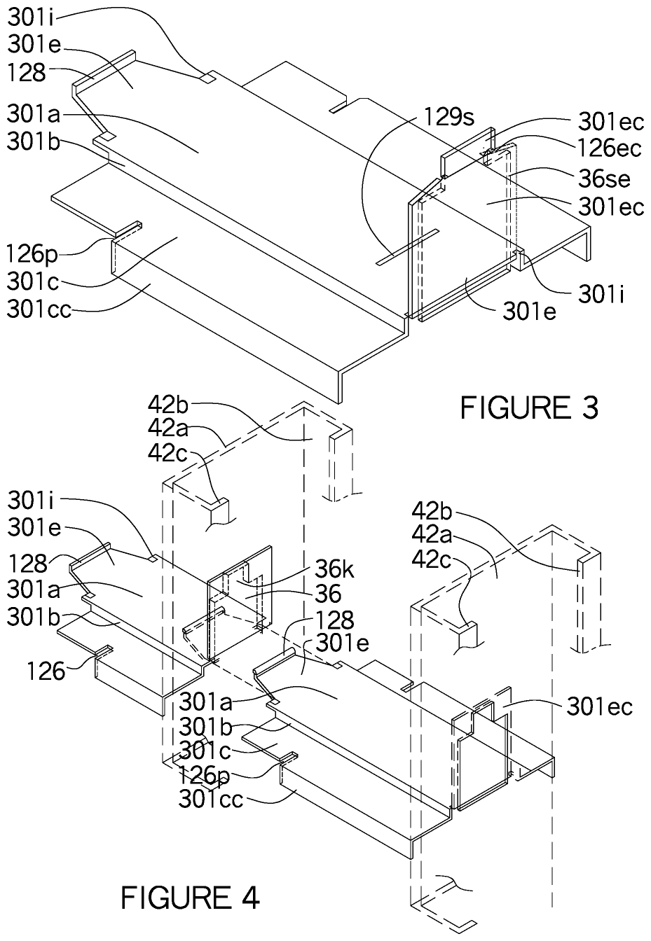

FIG. 3 is an enlargement of the spacing-bracing member described in FIG. 4 with the reverse lip spacer brace 301 as described in FIGS. 1 & 4, but is shown here having a wider web 301a spanning greater than the distance between the adjacent support members with flanges 301b extending downward from the web 301a and stopping at the webs 42a of the C channels 42 also described as support members. The free edge of the flanges 301b have lips 42c extending the width of the web 42a of the support members and having a cut outs in the lips 42c intersecting the spacing bracing member. The lips 301c are indented slightly so the edge of the lip 301c abuts the interior surface plane of the flange 42b and the inside surface of the lip 42c of the support member. The lip 301c can be further extended upward or downward forming a, double lip 301cc that is can abut the edge of the flange 42b or be wider to extend over the flange 42a of the support member where additional fasteners can be installed if desired. The left end of the spacing-bracing member shows the web 301a can extend into hole notches 126h of the web 42a in the metal framing member. The extension 301e is supported at the hole bottom edge 36be with the extension 301e having tapered side edges to form the hook tongue 128 with the tongue 128t extending upward. The tongue 128t extends upward so the tongue 128t can extend into the receiver slot hole 129s shown here near the right end of the spacing-bracing member. The tongue 128t is shown in other FIG's having different configurations. The right end of the reverse lip spacer brace 301 where the web 301a has a larger extension becomes an extension cover 301ec that fits against the web 42a of the support member with the extension cover 301ec supported by the extension 301e at the first end of an adjacent reverse lip spacer brace 301 having already occupied the same hole 36 of a metal framing member.

FIG. 4 shows the same spacing-bracing member as described in FIG. 3 except the hook tongue 128 on the left side has an additional bend at the tongue 128t leaving the end of the tongue 128t with the additional bend having more resistance for the tongue 128t more difficult to be removed from the receiver slot hole 129sh. In FIG. 3 the extension cover has a bend near the top of the extension cover 301ec where the extension cover notch 126ec occurs when a portion of the extension cover 301ec is allowed to extend to the opposing side of the web 42a of the metal framing member. The extension cover 301ec is another element of the fire shield connector with the spacing-bracing member 301 forming a fire shield all as one piece versus having different components to form a conceal compartment between metal framing members and spacing-bracing members to confine a potential fire within these fire chambers.

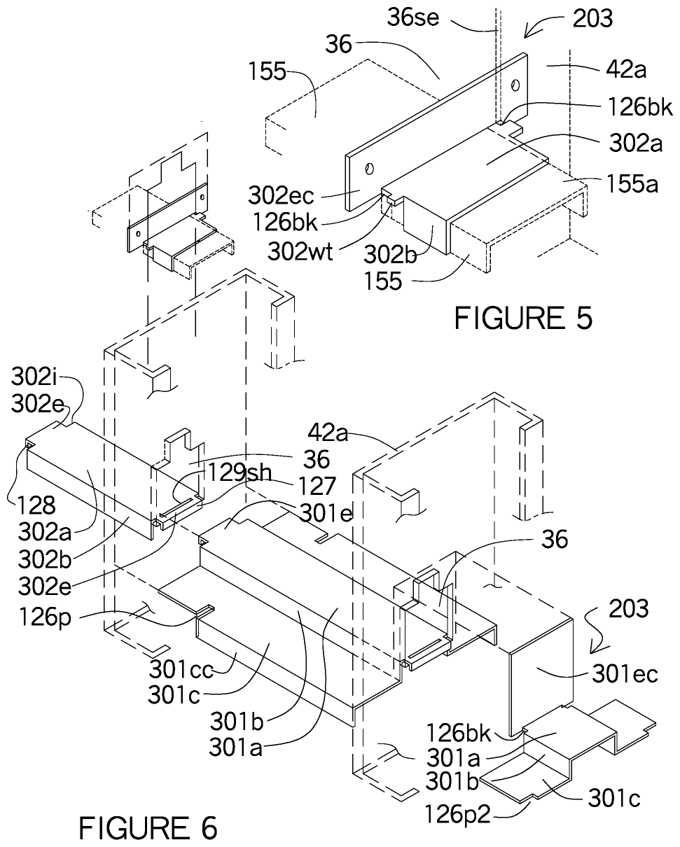

FIG. 5 shows an L-shaped bracket 203 where the L-shaped bracket 203 is installed over a horizontal bracing channel 155. Since the horizontal bracing channel 155 is narrow in width than the width of the hole, the L-shaped bracket 203 has a web tab 302 at that beyond the hole side edges 36se. The L-shaped bracket 203 is a U shaped spacer brace 302 having a web 302a with flanges 302b that extend downward that engages the hole bottom edge 36be with the web 302a having an extension 302e and where the extension 302e is wider than the width of the hole 36 that when placed against the opposite side of the web tabs 302wt the extension 302e then forms an extension cover 302ec. The space between the extension cover 302ec and the web tabs 302wt form a web cutout 126wk that is really a notch that fits into the hole side edges.

FIG. 6 has the same profile as FIG. 1, however on the right side of the support member shows an L-shaped bracket 203 that is different than the L-shaped bracket 203 shown in FIG. 5. The L-shaped bracket 203 shown in FIG. 6 has the extension cover 302ec on the same side as the L-shaped bracket 203 rather than having the extension cover 302ec on the opposite side of the hole 36. This version of the L-shaped bracket 203 is described more fully in FIG. 36.

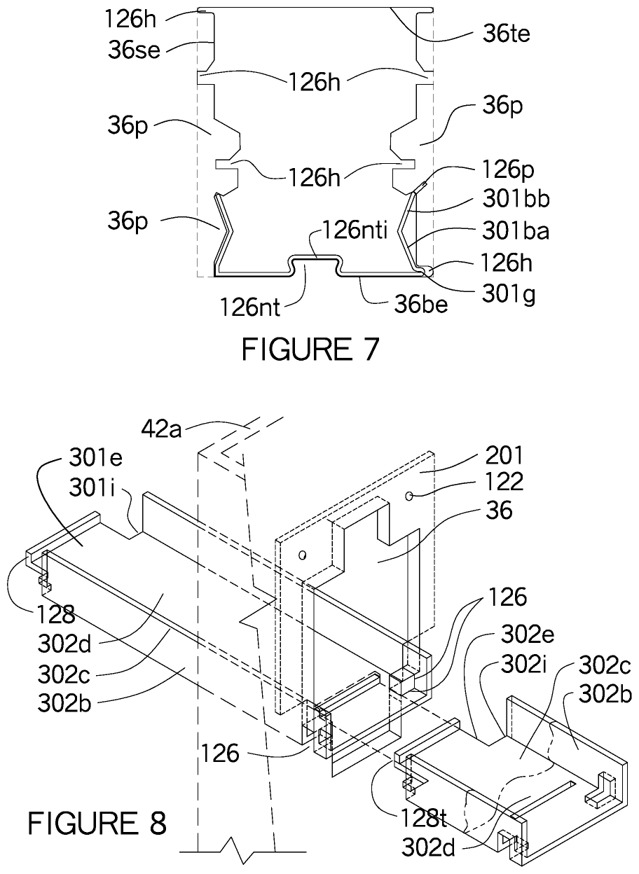

FIG. 7 shows a hole 36 used in the web 42a of a metal framing member. The hole 36 can be any shape; however the dashed line around the hole 36 is a typical rectilinear shape hole that is typically formed when manufacturers produced the metal framing members. The hole 36 shows protrusions 36p extending inward from the interior edge of the protrusion 36p with the sides of the hole notches 36p are located in the area occupied by the protrusion 36p with the back edge of the hole notch 126h being the hole side edges 36se. The two holes notches 126h at the hole top edge 36te as well as the lower right hole bottom edge 126h are hole notches 126h where one edge of the hole notches 126h is the hole top edge 36te or the hole bottom edge 36be as one edge of the hole notch 126h with the back edge of the hole notch 126h being the hole side edges 36se with the third edge being cut from the hole protrusion 36p. Other hole notches 126h are shown in the hole protrusions 36p. The bottom right hole notch 126h is shown with a bulge 301bg shown as a bulge 301bg where the flange 301b and the web 301a form the bulge as shown as a reverse lip spacer brace 301. The reverse lip spacer brace 301 is shown with a notched tab 126nt shown as an extension from the hole bottom edge 36be and where the web 301a has a notched tab indentation forming a concave indentation duplication the configuration of the notched tab extending from the hole bottom edge 36be. The flanges 302b of the reverse lip spacer brace 301 show a bent flange 301ba and another bent flange 301bb forming the flanges 302 and where the distal end of the bent flange 301bb has a lip 301c extending from the longitudinal edges. The lip 301c is shown with a lip notch 126p with the lip notch 126p connecting to the bottom edge of the hole protrusion 36p. The left side of the hole protrusion 36p at the reverse lip spacer brace 301 has the left hole protrusion 36p conform to the configuration of the bent flanges 301ba & 301bb while the opposing side edge of the hole protrusion 36p is straight conforming to the usual shape of a hole 36. The various hole notches 126p can have an element extend through the hole notch 126 or have the hole notches 126p have the element have a notch as shown by lip notches 126p connect having the back edge of the lip notches 126p engage the back edge of the hole notches 126h.

FIG. 8 shows an alternative solution to spacing-bracing member configuration as well as a flat plate 201 being installed over the hole 36 in the metal framing support member. The flat plate 201 is shown connected to the web 42a of the support member where the flat plate 201 is larger than the hole 36 and where the flat plate 201 is configured so as to fit between the web 302a and flanges 302b in order to form a fire shield between both sides of the web 42 of a support member. FIGS. 33 & 34 are similar however the web 302w is a continuous web notch connecting the flange-web notch 126fw into a continuous flange-web notch 126fw. FIG. 8 shows a U shape spacer brace 302 having a web 302a being supported at the hole bottom edge 36be of a support member with flanges 302b extending upward from the web 302a. The right longitudinal end of the U shape spacer brace 302 shows a flange-web notch 126fw at the intersection of the web 302a and flange 302b forming a continuous notch between the web 302a and flange 302b. FIG. 8 shows a key hole 36k at the hole bottom edge 36be where a smaller size hole is connected to the larger hole. The back edge of the flange portion of the flange-web notch 126fw is support at the hole bottom edge 36be of the larger hole 36 and the web portion of the flange-web notch 126fw has the side edges of the key hole 36k securing the web portion of the flange-web notch 126fw. FIG. 8 shows a hook tongue 128 having an extension 302e with the tongue portion extending upward from the hole bottom edge 36be requiring the hook tongue longitudinal end to be installed prior to adjoining the second U shaped spacer brace 302 shown to the left with the flange-web notch 126fw into the hole 36. The hook tongue 128 is shown extending upward for a vertical plate or separation can be installed across the hole 36 opening. The same configuration can also have the tongue end of the hook tongue 128 extending downward. FIGS. 33 & 34 are similar however the web 302w is a continuous web notch connecting the flange-web notch 126fw into a continuous flange-web notch 126fw.

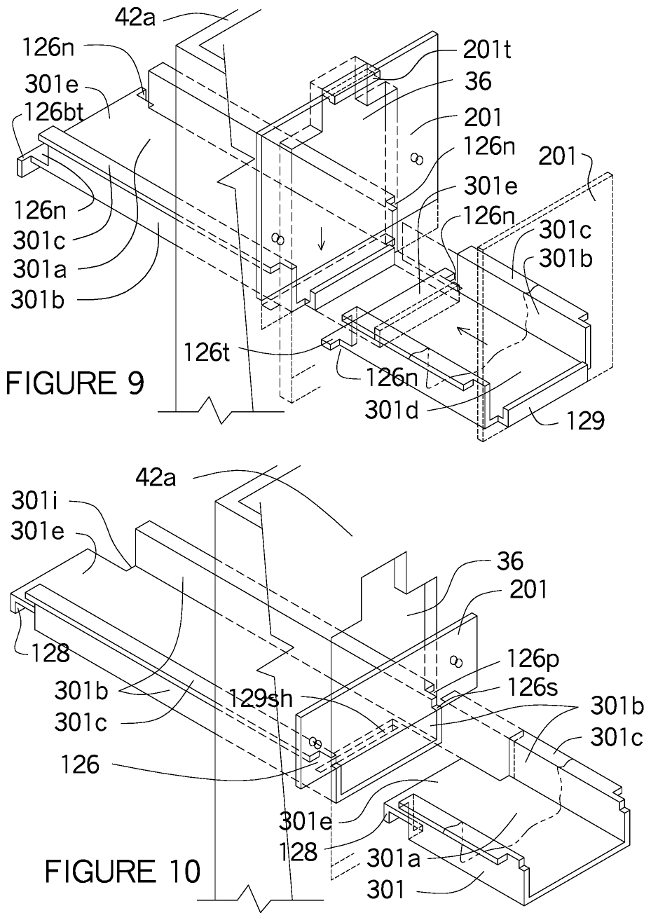

FIG. 9 shows two U shaped spacer braces 302 having a web 302a with flanges 302b extending downward from the longitudinal side edges of the web 302a with the left longitudinal end has indentations in the flanges 302b and web 302a with the remaining portion of the web 302a having an extension 302e being the arm of the hook tongue 128 with the end of the hook tongue extending upward as also described previously. The right longitudinal end of the U shaped spacer brace 302 also has the indentation at the flanges 302b and web 302a with the remaining portion of the web 302a having an extension 302e that extends over the hole bottom edge 36be and being the arm of a hook finger 127 that extends against the web 42a of the support member while the longitudinal ends of the flanges 302b supports the opposing plane of the web 42a. The tongue 128t end of the hook tongue 128 extends upward against a flat plate 201 that completes the U shaped spacer braces 302 from moving laterally as well as vertically as the flat plate 201 has fasteners to secure the web 42a and U shaped spacer braces 302 together. At the hole top edge 36te shows a metal plate tab referred to as a plate tab 201t that extends outward from the web 42a from the hole top edge 36te. The hole top edge 36te has the plate tab 201t can easily connect to the metal plate 201 and secure the metal plate 201 to the web 42a. In the right U shaped spacer brace 302 shows a large flat plate 201 that fully covers the hole 36 installed in the hook receiver 129. As mentioned earlier the flat plate 201 can be used as a fire shield separating the air gaps or as mention in this application as fire chambers that exist between adjacent support members.

FIG. 10 shows an isometric view of two U shaped spacer braces 302 having a web 302a with flanges 302b extending downward from the longitudinal side edges of the web 302a with the left longitudinal end with the flanges 302b and web 302a being indented with an extension 302e forming the arm of a hook tongue 128 where the tongue end extends downward along with the flanges 302b. The opposing longitudinal end of the U shaped spacer brace 302 shows flange notches 126fg with the opening beginning at the longitudinal edges of the flanges 302b with the side edges extending toward the web 302a and indented from the right longitudinal end allowing the side edges of the flange 302b have enough bearing support at the right longitudinal end of the flange 302b. In addition the right longitudinal end shows a receiver slot hole 129sh to the left of the hole 36. The right longitudinal end of the left U shaped spacer brace 302 is installed in the hole 36 by first installing the U shaped spacer brace 302 at a slight angle so the flange notches 126fg can engage the hole bottom edges 36be before the adjacent U shaped spacer brace 302 with the hook tongue 128 with the tongue end can be inserted into the receiver slot hole 129sh. As stated earlier the U shaped spacer brace 302 or reverse lip spacer brace 301 can have various shapes as well as various types of receivers, notches and hook tongues to form additional configurations.

FIG. 11 shows two U shaped spacer braces 302 having a web 302a with flanges 302b extending downward from the longitudinal side edges of the web 302a with the left longitudinal end has indentations in the flanges 302b and web 302a with the remaining portion of the web 302a having an extension 302e being the arm of the hook tongue 128 with the end of the hook tongue extending upward as also described previously. The right longitudinal end of the U shaped spacer brace 302 also has the indentation at the flanges 302b and web 302a with the remaining portion of the web 302a having an extension 302e that extends over the hole bottom edge 36be and being the arm of a hook finger 127 that extends against the web 42a of the support member while the longitudinal ends of the flanges 302b supports the opposing plane of the web 42a. The tongue 128t end of the hook tongue 128 extends upward against a flat plate 201 that stabilizes the U shaped spacer braces 302 from moving laterally as well as vertically as the flat plate 201 can have fasteners 122 to secure the web 42a and U shaped spacer braces 302 together. As mentioned previously the spacing-bracing member is used as a fire shield separating the air gap between adjacent support members and the flat plate 201 and used as another fire shield to seal the hole 36 of the a metal framing support

FIG. 12 shows an isometric view of two U shaped spacer braces 302 having a web 302a with flanges 302b extending downward from the longitudinal side edges of the web 302a with the left longitudinal end with the flanges 302b and web 302a being indented with an extension 302e forming the arm of a hook tongue 128 where the tongue end extends downward along with the flanges 302b. The opposing longitudinal end of the U shaped spacer brace 302 shows flange notches 126fg with the opening beginning at the longitudinal edges of the flanges 302b with the side edges extending toward the web 302a and indented from the right longitudinal end allowing the side edges of the flange 302b have enough bearing support at the right longitudinal end of the flange 302b. In addition the right longitudinal end shows a receiver slot hole 129sh to the left of the hole 36. The right longitudinal end of the left U shaped spacer brace 302 is installed in the hole 36 by first installing the U shaped spacer brace 302 at a slight angle so the flange notches 126fg can engage the hole bottom edges 36be before the adjacent U shaped spacer brace 302 with the hook tongue 128 with the tongue end can be inserted into the receiver slot hole 129sh. As stated earlier the U shaped spacer brace 302 or reverse lip spacer brace 301 can have various shapes as well as various types of receivers, notches and hook tongues to form additional configurations.

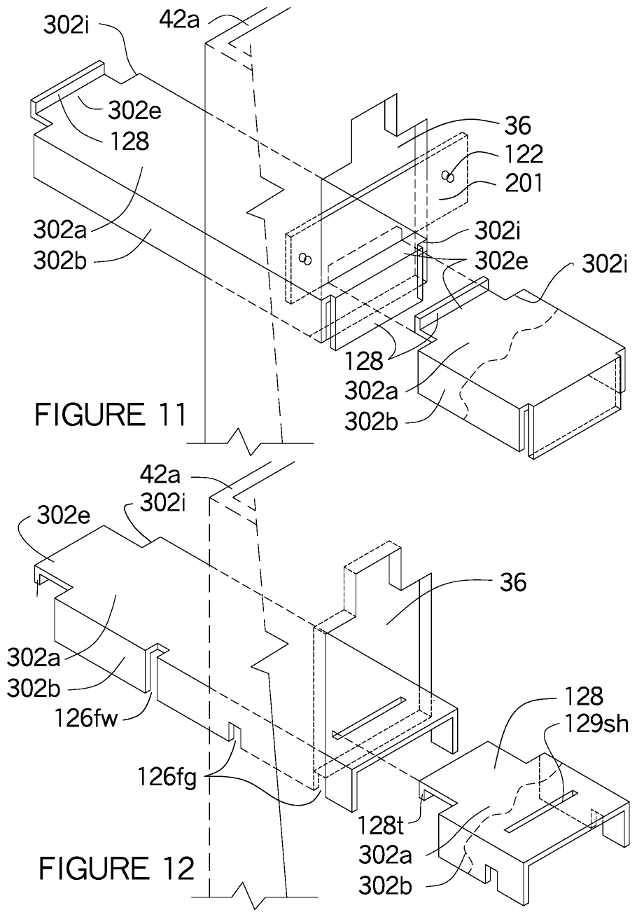

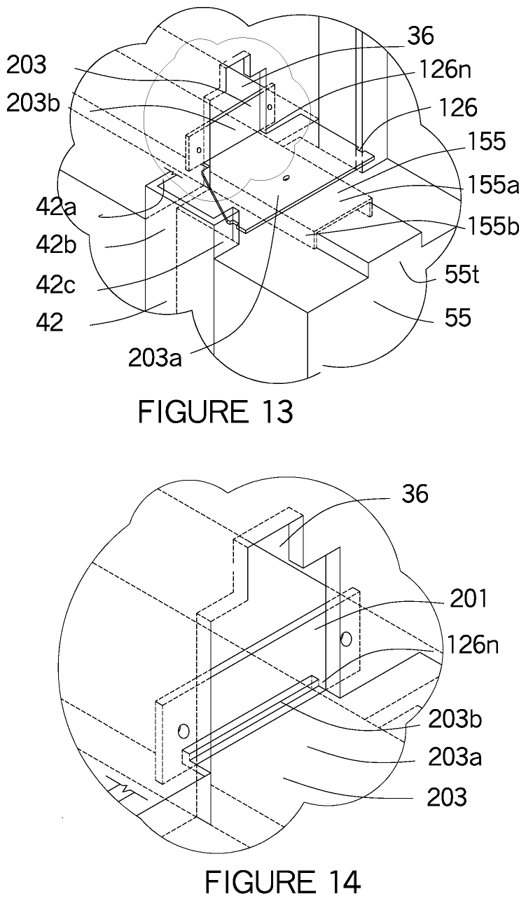

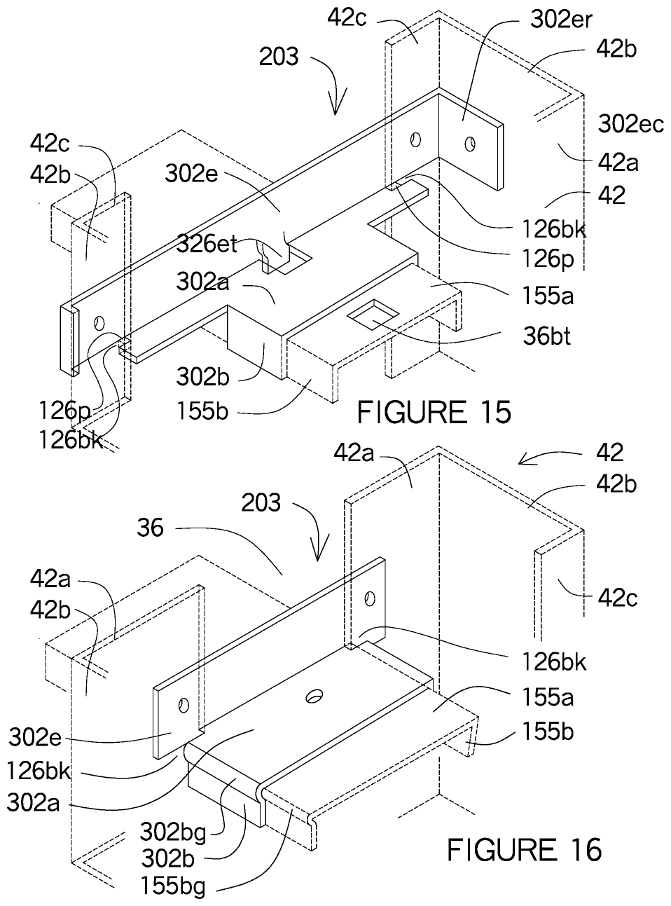

FIGS. 13 & 14 are similar to FIGS. 15 & 16 where the bracing member is shown as a U shaped channel 155 facing downward over the horizontal tongue 55t of the spacer block 55 leaving the top side 155a to attach to a one piece multi-plane bracket shown as an L-shaped bracket 203. One side 203a of the L-shaped bracket 203 is connected to the top side 155a of the bracing member and connected by a ½ notch 126n that engages the interior surface of lip 42c of the support member shown as a C channel 42. The other side 203b of the L-shaped bracket 203 is longer than the width between the lips 42c and is located on the exterior surface or the lips 42c to form the other side of the ½ notch 126n. In addition side 203a is longer so the length extends past the lips 42c of the support member and has a width larger than the distance between the lips 42c so notches can be formed on both sides to engage the side edges of the lips 42c of the C channel 42. In FIG. 13 the L-shaped bracket 203 shows the intersection of the side 203a and side 203b in the enlarged area shown as C-11, but the intersection in FIG. 14 is different. FIG. 14 shows a two-piece bracket comprising L-shaped bracket 203 and a flat plate 201. Even though both FIGS. 13 & 14 appear to look the same FIG. 14 shows the intersection at the hole 36 totally different. In FIG. 14 the side 203a is horizontal and wider than the width of the hole 36 and then is reduced to the width of the hole 36 extending past the hole 36 then turned to form a vertically oriented side 203b. The wider width of the horizontally oriented side 203a is reduced to pass through the hole 36 forms ½ notches 126n. The vertically oriented side 203b does not need to be long, just long enough to support a flat plate 201 that fits vertically between the vertically oriented side 203b and the outer surface of the web 42a of the support channel shown as a C channel 42. The other ½ notch 126n is formed when the flat plate 201 is installed vertically and fits against the vertically oriented side 203b and the web 42a.

FIG. 15 shows an isometric view a one piece bracket shown as an L-shaped bracket 203 where one side is connected to the horizontal bracing channel 155, connected by a ½ notch 126a that engages the lip 42c of the support member and the vertical side becomes the opposite side of the ½ notch 126a engaging the outer side of the lip 42c. The U-shape horizontal bracing channel 155 is shown with its dorsal side of the web 155a facing upwards shown with tab holes 36t and where the U shape bracing channel 155 extends over the hole bottom edge 36be of the hole 36 in the C channel 42 of the metal framing member. The L-shaped bracket 203 has a similar profile to a U shaped spacer brace 302 however the L shaped bracket 203 has a wider web 302a that fit over the U shaped bracing channel 155 and has flanges 302b extending downward over the flanges 155b of the U shaped bracing channel that spans between adjacent metal framing members. The L shaped bracket 203 shown In FIG. 15 connects the opening between the lips 42c of the C channel 42. The web 302a has web-leg extensions 302age that extending away from the flanges 302b past the lips 42c with the end of the web-leg extension 302age having web-leg notches 126ag. The web-leg extensions 302age has a vertical leg extension 302vge, where the vertical leg extension 302vge abuts the outside edge of the lip 42 of the C channel to form a ½ web-leg notch 126ag and the web-leg extension 302 forming the other ½ web-leg notch 126ag. The web 302a shows punch out tabs 326 with the extending tabs 326t extending into the tab whole 36t at the web 155a of the U shape channel 155. The L-shaped bracket 203 can also be used as an extension cover that is the vertical leg 203b can be used to close the opening of a whole 36 in the web 42a of a support member.as shown in FIG. 16.

FIG. 16 is similar to FIG. 15 except here the L-shaped bracket 203 has the vertical leg 203b spanning the hole 36 in a support member and the vertical leg 203b is connecting the web 42a. The horizontal leg 203a is shown in FIG. 16 having a bugle 203bg occurring between the horizontal leg and the flange 302d. The bulge flange notch 126fg occurs at the bulge 302bg and the horizontal leg 203a and the vertical leg 203b so the bugle flange notch 126fg can fit into the whole side edges 36se and the vertical leg 203b can seal off the whole 36 in the web 42 of the metal framing member. If the horizontal bracing channel 155 had a bulge 155bg, then the L-shaped bracket 203 would fit over the smaller bulge 155bg of the horizontal bracing channel 155 and no fasteners 122 would be required to secure the two members together.

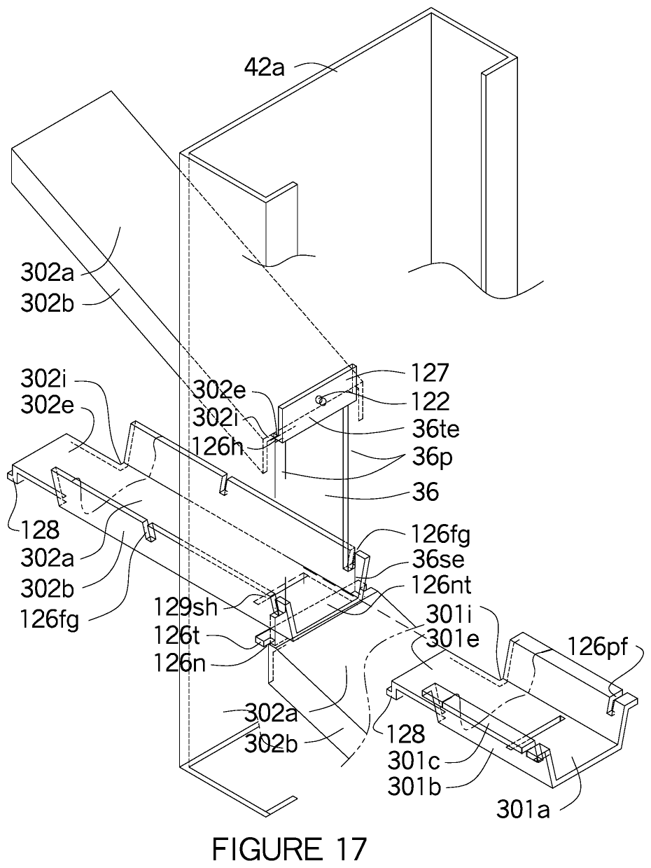

FIG. 17 shows two horizontally oriented U shaped spacer braces 302 intersecting at hole 36 where the right longitudinal end of the web 302a is supported at the hole bottom edge 36be with the longitudinal side edges have flanges 302b that extend upward away from the hole bottom edge 36be. The left end has the hook tongue 128 at the web 302a and the right end has the receiver shot hole 129sh for the hook tongue 128 to extend into when connecting adjacent U shaped spacer braces 302 together as previously described. The right longitudinal end has flange notches 126fg where the flange notches 126fg that extends into the whole side edges 36se and the whole protrusion 36p. In application U.S. Ser. No. 15/724,137 hole protrusions 36p are used and are shown here extending into the flanges notches 126fg that secures the U shaped spacer brace 302 from moving laterally as well as vertically. Many different shapes of spacer braces with lips 301c and without lips can restrict the horizontal and vertical movement within the holes 36 of the metal framing member. At the hole top edge 36te shows a diagonal oriented U shaped spacer brace 302 where the flanges 302b and web 302a are indented with a hook finger 127 extending from the web 302a across the hole top edge 36te with the finger end extending upward so a fastener 122 can be connected to the web 42a. The extension 302e is inserted into a hole notch 126h or a hole protrusion 36p where the extension 302e so as to form a hole notch 126h to accomplish the same function of preventing horizontal and vertical movement as well as the hook finger 127 and the longitudinal end edge also securing the web 42. At the hole bottom edge 36be the U shaped spacer brace 302 is shown intersecting the hole bottom edge 36be at a diagonal where the longitudinal end of the web 302a shows the notched tab 126nt end fitting against the hole side edges 36se or into a hole notch 126h (not shown). In this case the downward oriented diagonal U shaped spacer brace 302 is inserted into the hole bottom edge 36be first where the longitudinal end has notch tab 126nt where the notches 126n fit against the hole side edges 36se with the tabs 126t and the longitudinal edges of the flanges 302b engage both sides of the web 42a of the support member. After the lower U shaped spacer brace 302 is installed over the hole bottom edge 36be, the first horizontal U shaped spacer brace 302 previously described is installed over the longitudinal end of the notched tab 126nt of the diagonal U shaped spacer brace by installing the U shaped spacer brace 302 at an angle then turned so the flange notches 126fg can engage the underside of the hole protrusion 36p first. The previously mentioned identical U shaped spacer brace 302 with the hook tongue 128 on the left longitudinal end can then be inserted into the receiver slot hole 129sh of the second U shaped spacer brace 302. Obviously different longitudinal ending connections can be used to form a rigid connection between the metal framing members. FIGS. 8 & 19 shows how a flat plate 201 can be installed over the hole 36 for the U shaped spacer brace 302 is used also as a fire shield.

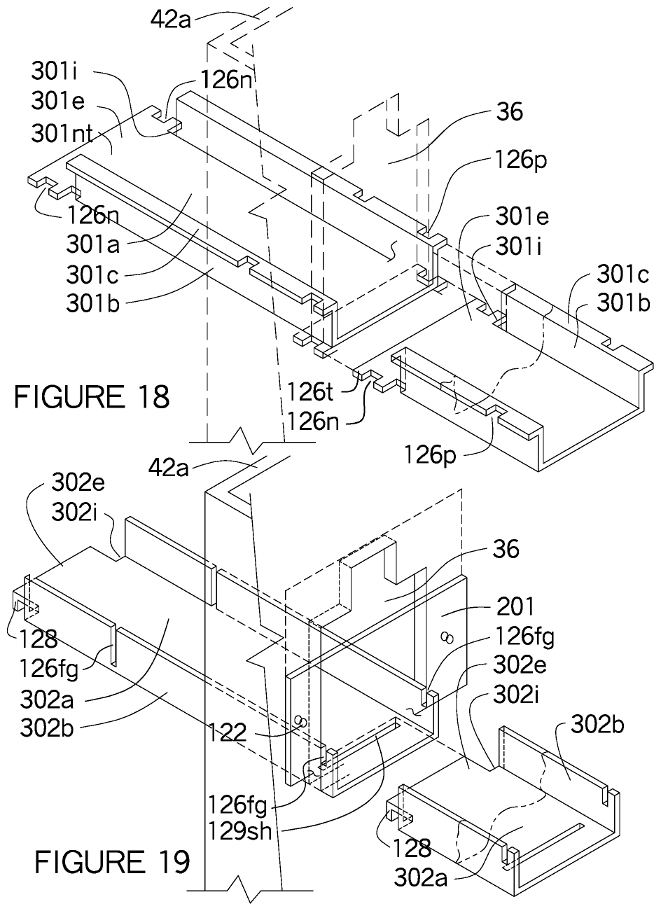

FIGS. 18 & 19 both show an exploded isometric view of two upward facing U shaped spacer braces 302 having a web 302a and two parallel sides 302b extending upward on both sides of the U shaped spacer brace 302. Both FIG's show the web 302a on the left end having extensions 302e that extend over the hole bottom edge 36be of the metal framing member shown as a C shaped channel 42 having a hole 36. In FIG. 18 the left side shows the notched tab 126nt at the left end being installed into the hole bottom edge 36be for the right end of an adjacent spacing-bracing member to fit over. Since the U shaped spacer brace is connected at the flange notches 126fg, the flange notches 126fg are indented from the right end of the connect.

In FIG. 19 the U shaped spacer braces 302 show the web 302a on the left side having an indentation 302i and an extension 302e with a downward oriented hook tongue 128. The right side of FIG. 19 has the side edges 302b at the end extend outwardly so the outer edge of the side edges 302b would extend past the hole side edges 36se when the U shaped spacer brace 302 is inserted into the hole 36. In addition, the right side has a receiver slot hole 129sh in the web 302a for the hook tongue 128 to fit into connecting the two U shaped spacer braces together. The right side of FIG. 19 has flange notches 126fg at the top edge of the side edges 302b. When the right side is installed into the hole 36 a flat plate 201 is installed into the flange notches 126fg. The flanges notches 126fg can be the full height depth of the flanges 302b allowing the flat plate 201 to extend to the web 302 forming a great fire stop at the hole 36. The hook tongue 128 on the left side fits over the web 302a of the left U shaped spacer brace 302 and into the receiver slot hole 129sh.

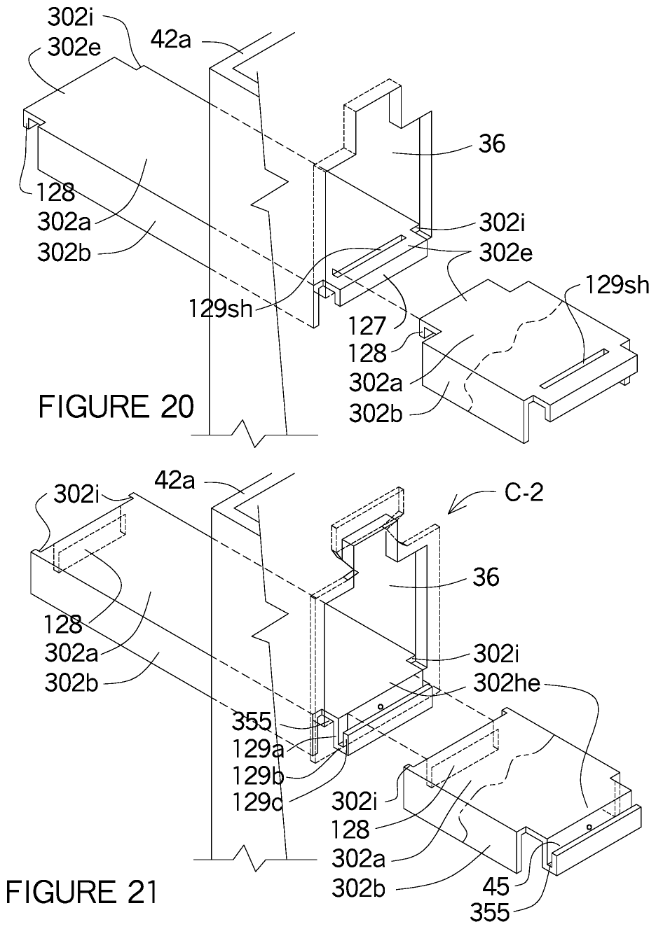

FIG. 20 shows two horizontal oriented U shaped spacer braces 302 connected together at a hole 36 of a support member. Where the flanges 302b have a cut out along with the web 302a having an indentation 302i with the end of the flanges 302b and web 302a abut one side of the web 42a of the C channel 42. The indentation 302i allows the web 302a to have an extension 302e that passes through the hole 36 over the hole bottom edge 36be and continues to form a hook finger 127 that extend downward over the hole bottom edge 36be and against the planar surface of the web 42a. The web 302a has a receiver slot hole 129sh near the hole 36. The opposing end of the U shaped spacer brace 302 has the web 302a and flanges 302b also abut the planar surface of the web 42 of a support member with the web 302a having an extension 302e. The extension 302e has a hook tongue 128 at the end with the tongue 128t extending into the receiving slot hole 129sh. The hook tongue has a notched-tab 126nt at the end which is installed over the hook finger 128 and web 302a of the first U shaped spacer brace 302. The web extension 302we is wider than the width of the receiver slot hole 36rs of the first U shaped spacer brace 302 so notches 126ntn can be bent and installed at the side edges of the web extension 302we and then inserted into the web slot hole 36we. The notched-tab 126nt at the tongue 129t keeps the tongue 129t the U shaped spacing-bracing members engaged to each other.

FIG. 21 shows the U shaped spacer brace 302 having an elongated body having a web 302a with two flanges 302b extending downward from the web 302a with both ends of the elongated U shaped spacer brace 302 having the side edges of the flanges 302b engaging the web 42a of the support members forming the first engagement connection between framing members. The U shaped spacer brace 302 is slightly narrower as only the flanges 302b abut the web 42a of the support member. On the right side the web 302a of the U shaped spacer brace 302 has an indentation 302i and an extension 302e when abutting the web 42a of the C channel 42 shown as the support member. When the extension 302e spans over the anchor space 355 and extends over the bottom edge of the hole 36 a hook receiver 129 is formed having a U-shaped configuration with the first leg 129a extends downward then bending 90 degrees forming a second leg 129b of a connection then bending 90 degrees again forming an upward oriented third leg 129c leaving a gap 45 between the first and third legs 129a & 129c forming the second engagement connection between framing members. By bending the first leg 129a on the opposite side of the web 42a from the end of the flanges 302b the U shaped spacer brace 302 is now engaged. To the right of the hook receiver 129 shows an another U shaped spacer brace 302 with a hook tongue 128 on the left side and the two flanges 302b extending beyond the hook tongue 128 so the two flanges 302b can extend beyond the hook receiver 129 and abut the web 42a of the support member. The hook tongue 128 extends downward from the web 302a over the third leg 129c of the hook receiver 129 into the gap 45. The hook tongue 128 extends downward from the web 302a over the third leg 129c of the hook receiver 129 into the gap 45 where another anchor space 355 exists when the hook tongue 128 rests on the gap side of the second leg 129b. The third engagement connection between framing members occurs when the hook tongue 128 fits into the gap 45 between the downward oriented first leg 129a and upward oriented third leg 129c thereby engaging two U-shaped spacer braces 302 together. In FIG. 21 the hook receiver 129 is shown having a flat plate installed in the hook receiver 129 along with the hook tongue 128 from an adjoining U shaped spacer brace. The flat plate 201 is shown having an extra bend as shown in FIG. 3 where the web 301a is extended forming an extension cover 301ec. The extra bend in the flat extension plate 201 is referring to the same configuration as shown in the extension cover 301ec. On the other hand, the flat plate has the bottom edge installed in the hook receiver 129 where the leg 129b is wider so the flat plate 201 and a hook tongue 128 from an adjoining U shaped spacer brace 302 can also be installed in the hook tongue 128.

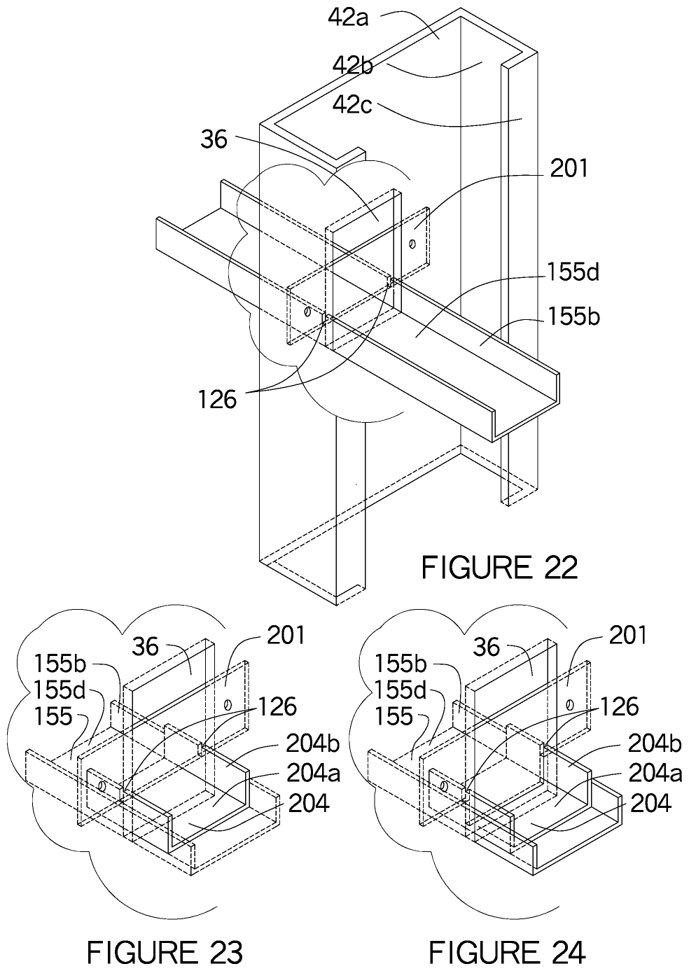

FIG. 22 shows a U channel 155 having a web 155a with flanges 155b extending upward from the web 155a with the web 155a resting on the hole bottom edge 36be. The flanges 155b have flange notches 126fg for a flat plate 201 to fit into with the flat plate 201 connected by fasteners 122 to the web 42a of the metal framing member. The flat plate 201 can be large enough to completely cover the hole 36 forming a closed chamber between the two sides of the web 42 as shown in FIG. 23 and again shown in FIG. 24 when a reverse lip spacer brace 301 is used. A reverse lip spacer brace 301 shown having wide lips 301 (not shown in this FIG.), but having similar lips 301c shown in FIGS. 1 & 2. The reverse lip bracket 208 is similar to fire shield described as a reverse lip spacer brace 301 but described here as having a narrower web 301a where the web 301 would fit between the flange 155b of the U channel 155. The reverse lip bracket 208 uses the same principle as discussed when the flanges 208b are installed between the flanges 155b of the U channel 155.

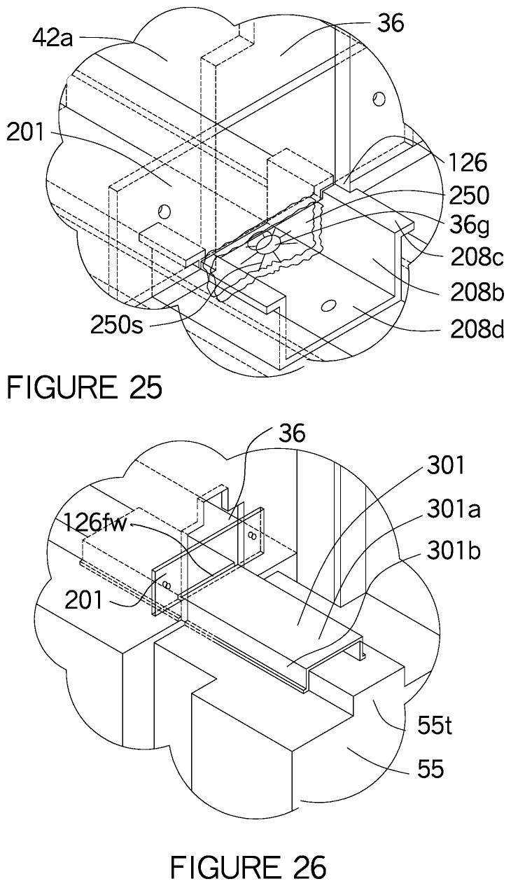

FIG. 25 has the same bracing member and two piece bracket construction is shown in FIG. 23 except a grommet 250 has been added. The grommet 250 is shaped so the top edge of the grommet 250 is concave, where the upper edges will extend on both sides of the bottom edge of the flat plate 201 and the remaining sides abut the parallel sides and bottom side of the reverse lip bracket 208. The grommet 250 has a hole 36g in the middle with slots 250s around the edges of the hole 36g in order for the hole 36g to be expanded larger to accommodate electric wiring (not shown) or other utilities to pass through as well as still maintaining a fire shield between metal framing members.

FIG. 26 shows a reverse lip spacer brace 301 extending through the hole 36 in the web 42a of the metal framing member. The web 301a has two flanges 301b extending from the longitudinal side edges of the web 301a with lips 301c extending outward away from the web 301a. The web 301a and flanges 301b extend through the hole 36 with the lips 301c having lip notches 126p. The lip notches 126p are indented at the lip 301c only partially allowing the lip 301c and the flange 301b to rest on the hole bottom edge 36be. The lip notches 126p is inserted into the hole side edges 36se. A flat plate 201 is installed in the web-flange notch 126fw that extends the full width of the web 301a and into the flanges 301b and connected to the web 42a of the metal framing support with fasteners 122 if desired. The reverse lip spacer brace 301 is shown installed over an spacer block having insulating properties as well as being fire block that provides a fire shield between the fire shield connectors shown through this application. A tongue side 55a is shown filling the void under the web 301a and between the flanges 301b. Different configurations are available where the lip 42c of the metal framing member can fit into a slot groove (not shown) rather than the cut out at the lip 42a. The lip-flange notches can also be used as a notch to connect to the hole protrusions 36p found in other drawings.

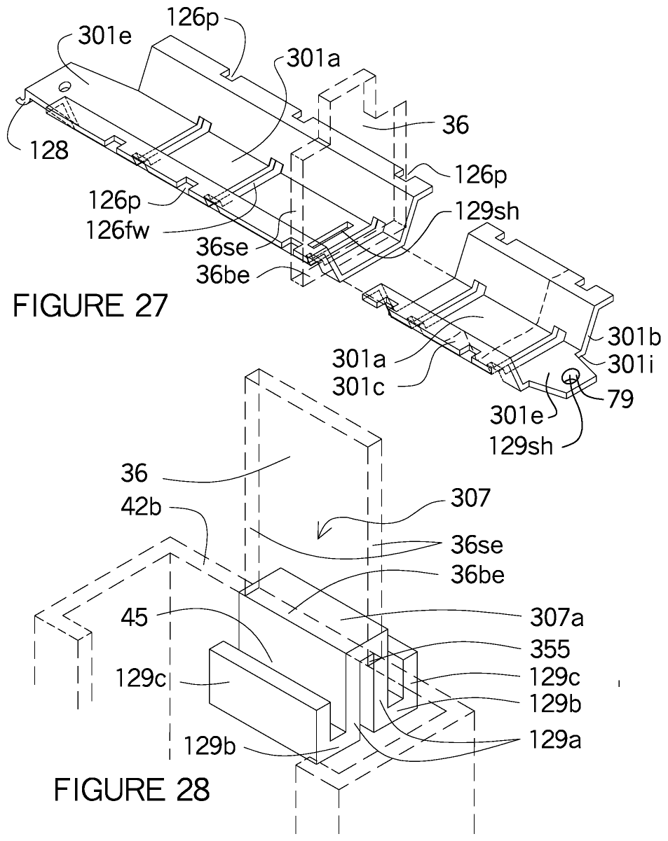

FIG. 27 show the two reverse lip spacer braces 301 each having a web 301a with the longitudinal side edges distal to the flanges 301b where the longitudinal edges of the flanges 301b have lip 301c extending outward away from the web 301a with the lips 301c have lip notches 126p extending inward toward the web 301a from the longitudinal edges of the lips 301c. The first reverse lip spacer brace 301 shown at the right side of the hole 36 with the right longitudinal end extending into the hole 36 engaging the hole side edges 36se at the lip notches 126p and where the web 301a and the flanges 301b have continuous flange-web notches 126fw. The flange-web notch 126fw engages the hole bottom edge 36be so the back edge of the flange-web notch 126fw at the flanges 301b is secured to the hole bottom edge 36be. When the second reverse lip spacer brace 301 has the right longitudinal end fit into the hole 36 the flange-web notch 126fw from the first reverse lip spacer brace 301 fits lower into the hole bottom edge 36be allowing the second reverse lip spacer brace 301 at the right longitudinal end to overlap the first reverse lip spacer brace 301. An alternative overlapping end connection solution is where the right reverse lip spacer brace 301 has an extension 301e at the web 301a with a receiver slot hole 129sh having a ledge 79. The opposing end of an adjacent reverse lip spacer brace 301 with a hook tongue 128 can connect adjacent reverse lip spacer braces. The hook tongue 128 with the tongue 128t can have a curvilinear end to wrap around the ledges 79 at the receiver slot hole 129sh.

FIG. 28 shows a W-shaped clip 307 fits at the hole bottom edge 36be of the support member with each end having hook receivers 129. In FIG. 21 the hook receiver is shown at the end of a U shaped spacer bracer 302 where the hook receiver 129 extends from the web 302a. In FIG. 28 the W-shape clip 307 has a horizontally oriented web 307a where the web 307a is the extension that fits over the thickness of the web 42a of the support member and extends over both the vertical side edges of the web 42a so a hook receiver 129 can be installed on both sides of the web 42a of the support member and the first leg 129a extends downward against the web 42a with the second leg 129b extending outward from the web 42a forming a gap 45 where the third leg 129c extends upward forming a U-shape hook receiver 129 on both sides of the web 42a of the support member. Any shape spacer brace can be used in and the hook tongue 128 for any spacer brace can fit into the W-shaped clip 307.

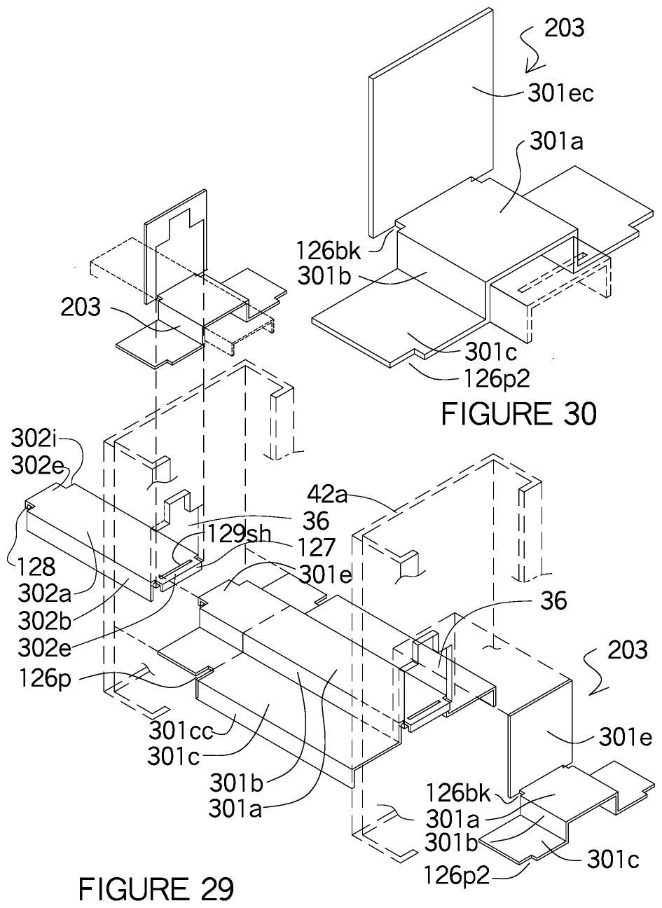

FIG. 29 shows the same reverse lip spacer brace 301 spanning between the holes 36 of two adjacent C channels 42 referred to as the metal framing members. The reverse lip spacer brace 301 shows the hook finger 127 extending over the hole bottom edge 36be at the right end with a receiver slot hole 129sh shown near the hole 36 for another reverse lip spacer brace 301 (shown here as a U shaped spacer brace 302) where the hook tongue 128 fits into the receiver slot hole 126sh. An enlargement of the larger L-shaped bracket 203 is also shown in FIG. 30 being configured as a reverse lip spacer brace 301 without the connector ends and without the double lips 301cc. The larger L-shaped bracket 203 has an overall configuration being the inside surface of the C channel 42 have a web 42a with extending flanges 42b being connected to lips 42c forming a C-shape. The larger L-shaped bracket 203 have the web 301a, flanges 301b and the lips 301c abut the inside plane of the web 42a of the metal framing member and the longitudinal edges of the lip 301c of the L-shaped bracket 203 with a cut out lip notch 126p2 at the lip 42c that also extends around the blunt edge of lip 42c. The web 301a of the L-bracket 203 has a web-cutout notch 126bk that has two side edges of the web-cutout notch 126bk being part of the web 301a with the third side edge being the extension cover 301ec that is formed as an extension of the web 301a. The extension cover 301ec is wider and taller than the width and height of the hole 36 in the metal framing member. The extension cover 301ec should have a narrow width in order for the extension cover 301ec to pass through the hole 36 rotated to a vertical position with the extension cover 126ec being a shield to prevent a fire from passing through the hole 36 then orient the web 301a and lip 301c over the reverse lip spacer brace 301 already installed between the adjacent metal framing members. The web 301a of the L-shaped bracket 203 is slightly larger as the web 301a and flanges 301b will fit over the web 301a and flanges 301b of the reverse lip spacer brace 301 as well as the web-cutout notch 126bk will fit into the hole side edges 36se of the hole 36 in the metal framing member. If the extension cover 301ec is too large in relation to the hole 36, the extension cover 301ec can vary in size to accommodate the different size of the hole 36. The web 301a can also extend under the hole notch 126h to keep the fire shield from vertical and horizontal movement.

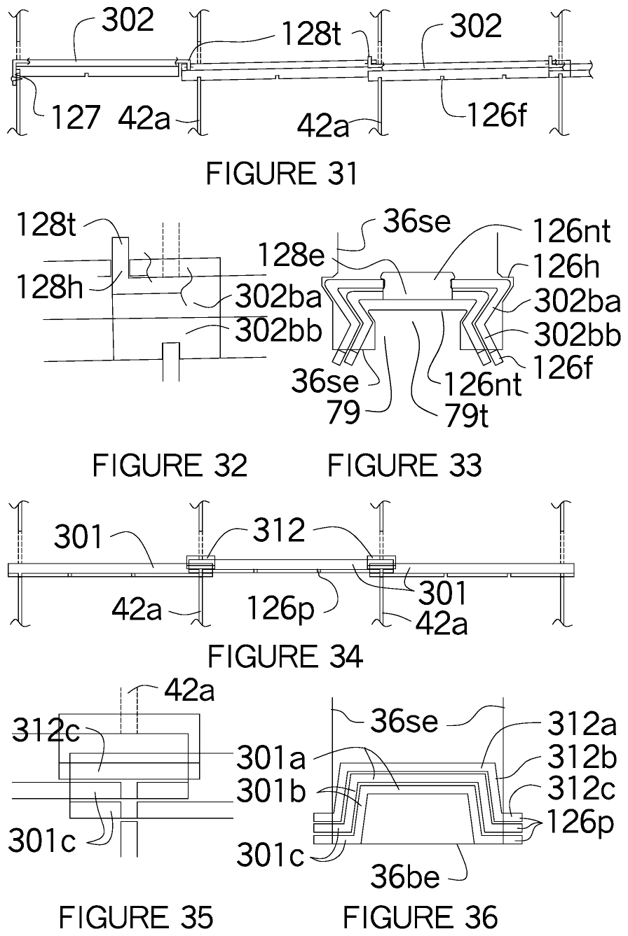

FIGS. 31-33 shows an elevation, enlargement and section of metal framing where the U shaped spacer braces 302 have a web 302a with bent flanges 302ba & 302bb with flange notches 126f inserted into the flange edges. The U shaped spacer braces 302 in FIGS. 31-33 are shown here with the flanges extending downward toward the hole bottom edge 36be with the first flange 302ba bent at an acute angle to the web 302a with the second flange 302bb bent at an obtuse angle to the first flange 302ba forming bulges 301g at both sides. The hole notch 126h at the web 302a and the first flange 302ba should be large enough to accommodate the acute angle bend. The lower U shaped spacer brace 302 has a narrower web 302a with shorter first flanges 302ba so as to fit under the larger U shaped spacer brace 302 above that is the U shaped spacer braces 302 can have one longitudinal end be larger with the opposing end being narrower in width. On the other hand a larger width reverse lip spacer brace 301 can fit over narrower width reverse lip spacer braces 301 shown similarly in FIGS. 45 & 48. FIG. 33 shows the hole bottom edge 36be extending upward from the web 42a of the metal framing supports forming a hole protrusion 36p of the hole bottom edge 36be being a notched tab 126nt that extends between the first flange 302ba and the second flange 302bb at both sides of the U shaped spacer brace 302 allowing the head or tongue 126t extend around the second flange 302bb so the tongue 126t has a greater width than the distance between the second flanges 302bb. The variation in distance will resist any upward force between the tongue 128t of the hook tongue 128 and the interior surfaces of the second flanges 302bb. The U shaped spacer braces 302 are overlapped at the hole 36 and both the upper and lower U shaped spacer braces have their lip notches engage the hole bottom edges. Another overlapping solution is when the upper spacing-bracing member having the larger width longitudinal end overlaps the longitudinal end of the narrower width U shaped spacer brace 302 the flanges 302bb and the flange notches 126f can be eliminated as the hook tongue 128 with the tongue 126t end from one spacing-bracing member overlaps and extends into the receiver hole 129h of the adjacent spacing-bracing member. The acute angle produced by intersecting the web 302a and flange 302ba of the wider U shaped spacer brace 302 overlapping and fitting over the smaller acute angle of the narrower width U shaped spacer brace 302 will also eliminate any vertical movement between the spacing-bracing members.

FIGS. 34-36 shows an elevation, enlargement and section of metal framing shows the reverse lip spacer brace 301 with a reverse lip bracket 312 with its flanges 312b fitting over the overlapping lower two reverse lip spacer braces 301 and still having the lip notches 126p of the bracket 312 engaging the metal framing support at the hole side edges 36se. The same reverse lip bracket 312 can be used and adjusted to fit the profile of other spacer braces allow the lip notches 126p engage the hole side edges 36se between metal framing supports. The width of the reverse lip spacer braces 301 and the width of the bracket 312 will vary depending on the width of the hole 36. When the reverse lip spacer braces 301 and the bracket 312 the webs 301a and lips 301c become longer in order for the bracket 312 and reverse lip spacer braces fit tight against each other. If a continuous web notch is added to the bracket 312, similar to the web-flange notch 126wf as shown earlier a flat plate 201 also shown in other FIGS. can be used seal off a fire chamber, then referred to as an extension cover 301ce.

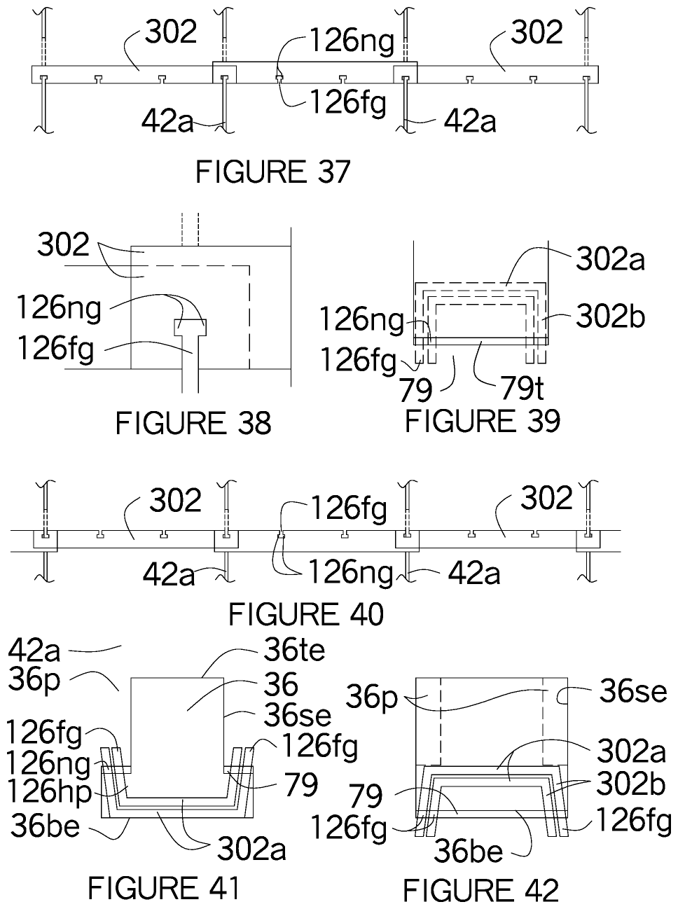

FIGS. 37-42 shows elevations, enlargements and sections of metal framing uses a U shape spacer brace 302 having a web 302a with flanges extending from the longitudinal web 302a and with flange gap notches 126fg that extend from the longitudinal open edges toward the web 302a having a T-shape notched gap 126ng extending horizontally from the longitudinal open edges of the flanges. FIGS. 37-39 show the U shape spacer brace 302 having the flanges 302b extending downward to the hole bottom edge 36be in the web 42a of the metal framing support. The hole bottom edge 36be has a ledge 79 extending from the hole bottom edge 36 so the T-shape notched gap 126ng can extend into the ledge 79 where the metal framing support has the ledge 79 facing either left or right giving the U shaped spacer brace 302 more flexibility during the installation. One end of the U shaped spacer brace 302 would have a larger width or narrow web 302a allowing for the U shaped spacer brace 302 to overlap the adjacent U shape spacer brace 302.

FIG. 40 & FIG. 42 are similar however the flanges 302b are angular allowing for a possible faster assembly. FIG. 42 shows protrusions 36p extending from the hole side edges 36se forming a protrusion hole notch 36ph where the hole bottom edge 36be, hole side edge 36se and the bottom edge of the hole protrusion 36p to keep the U shaped spacer brace from moving within the hole 36. As mentioned previously when overlapping the longitudinal ends, one longitudinal end will have a wider width to overlap the adjacent U shaped spacer brace 302. In addition, the wider width longitudinal end will have a web flange notch 126wf so the hole protrusion will fit tight against the smaller U shaped spacer brace 302 as well as the larger U shaped spacer brace 302. FIG. 41 has the same U shaped spacer brace 302 profile the U shaped spacer brace 302 has the web 302a resting on the hole bottom edge 36be. The bottom edge of the protrusion 36p is shown have a ledge 79, however that is not required to secure the metal framing support to the U shaped spacer brace 302. The protrusions 36p extend into the flange notches 126f at the flanges 302b. As shown in other overlapping solutions a smaller U shaped spacer brace 302 will fit into and between the flanges 302b of the larger U shaped spacer brace 302.

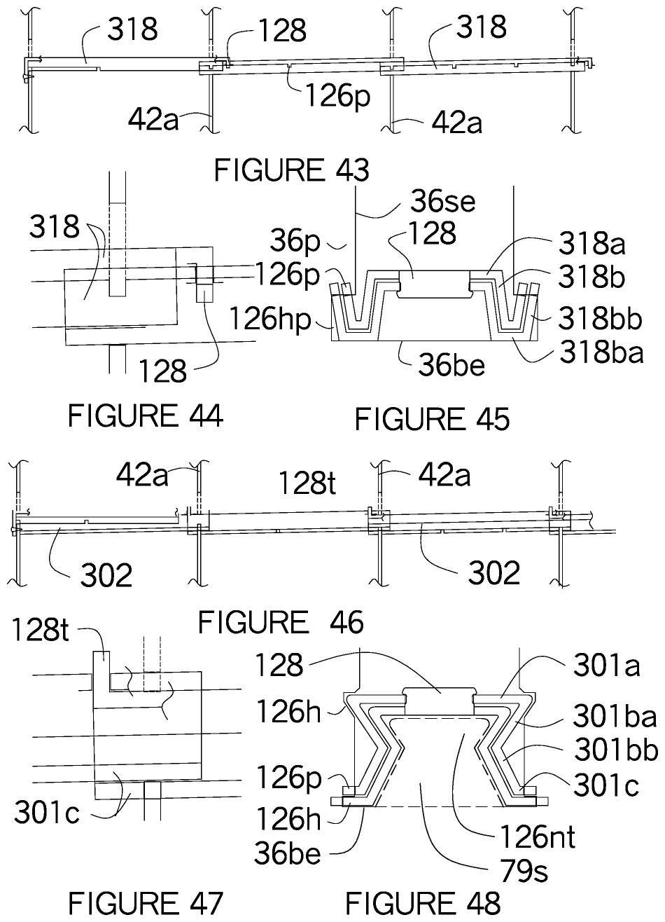

FIGS. 43-45 shows an elevation, enlargement and section of metal framing having a W-shape spacer brace 318 which is a combination of FIG. 41 & FIG. 42 where the end of the flanges 318bb have a flange notch 126f and where the flange notches 126f extend into the bottom edge of the ledges 79 extending from the hole side edges 36se. The W-shape spacer brace 318 has a web 318a with the first flange 318b extending downward away from the web 318a, then having the flange turn substantially parallel to the web 318 toward the hole side edges 36se with the last bend of the first flange 318b extending upward with the flange notch 126f having the open end engage the bottom edge of the protrusion 36p. A smaller width longitudinal end profile as required as explained above when adjacent W-shaped spacer braces 318 overlap each other. This configuration eliminates horizontal and vertical movement between the W-shaped spacer braces 318, however an extension 318e with a hook tongue 128 having a tongue 128t extend into a hole receiver 129h of the adjacent W-shape spacer brace 318 will also increase the connection strength between the two members.

FIGS. 46-48 shows an elevation, enlargement and section of metal framing is a combination of several spacer braces as the shape is similar to a reverse lip spacer brace 301 having bent flanges with the first flange 301ba extends downward toward the hole bottom edge 36be having an acute angle to the web 301a. The web/flange acute angle connect has the acute angle penetrating the hole side edges forming a hole notch 126h. The first flange 301ba is further extended having an obtuse angle between the first flange 301ba and the second flange 301bb with lips extending outward toward the hole side edges 36se with lip notches 126p extending inward at the longitudinal side edges of the lips 301a. Two adjacent reverse lip spacer braces 301 are shown overlapping each other at their longitudinal ends and where a smaller narrower reverse lip spacer brace 301 is installed into the hole 36 first with the lips 301c having lip notches 126p engaging the hole notches 126h at the hole bottom edge 36be allowing the lip notches 126p to be supported vertically at the top edge of the hole notches. A larger reverse lip spacer brace 301 is installed over the lower reverse lip spacer brace 301 where the acute angle connection described above occurs connecting the larger reverse lip spacer brace 301 to the hole notch 126h. The hole side edges 36se and the hole bottom edge 36be have another hole notch 126p for the lip notches 126p to extend into while the upper reverse lip spacer brace uses only the lip notches 126p to engage the hole side edges 36se. In addition the lower reverse lip spacer brace 301 has an extension 301e at the web 301a with an upward extending tongue 126t to engage the opposing end of the adjacent spacer brace having a hole receiver 129h in the web 301a for the tongue 128t to fit into. An alternative spacing-bracing member connection to the metal framing support is to have the hole bottom edge 36be with a ledge shaft 79s having a notched tab configuration 126nt (shown dashed lines) at the head extending into the longitudinal concave shape of the larger reverse lip spacer brace 301, so the larger side edge profile of the spacing-bracing members extend into the continuous notched tab notch 126cnt forming a concave relationship where the web 301a is in relationship to the top edge of the head of the notch tab 126nt, then having the flanges 301ba bent inwardly in an acute angle to the web 301a then the flanges 301bb are bent away from the flange 301ba forming an obtuse angle or a notch having an equivalent shape of the notched-tab notch 126ntn with the hole bottom edge 36be extending becoming the part the notched tab 126nt at the hole 36. The reverse lip spacer brace 301 having a notched tab profile as just explained is similar to the continuous notched tab profile as previously shown in FIGS. 7,33.

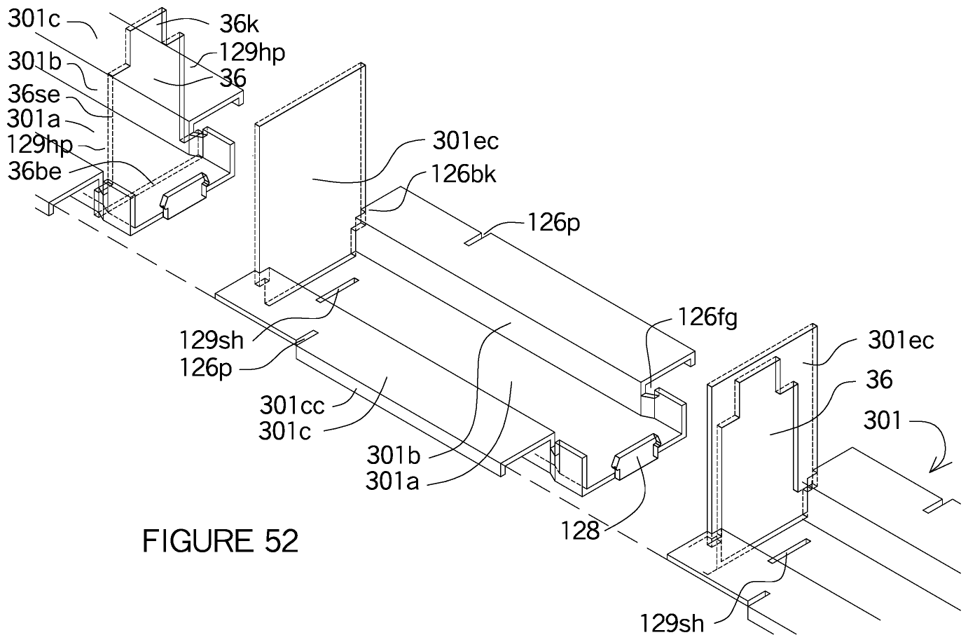

FIG. 49 shows the fire shield connector as a reverse lip spacer brace 301 having a web 301 with the flanges 301b extending upward and lips 301c extending away from the web 301a and with double lips 301cc that even with the flanges 42b of the metal framing member. The reverse lip spacer brace 301 has the right end has a lip-flange notch 126pf where the lip 301c, double lip 301cc and the flange 301b are notched with the only the web 301a and flange 301b extend through the hole 36 of a metal framing member. The right end extension that passes through the hole consists of the web 301a that is now wider with flanges 301b that are shorter in height. The end of the web 301a & flange 301b extension has a hook tongue 128 end with a tongue 128t end having a notch 126n at the base with a wider tongue 128t. The opposing end has extension cover 301ec that continues from the web 301a where the web extension cover is bent with the back side fitting against the web 42a of an adjacent metal framing member. When the left side of the fire shield connector is placed against the web 42a of the web 42a of the adjacent reverse lip spacer brace 301 has the web-flange extension protruding from the hole 36 that the hook tongue 128 extends into the receiver slot hole 129sh in web 301a. The tab 128 extends through the receiver slot hole 129sh having the tongue 1218t extend above the web 301a with the notch 128ntn engaging the sides of the web 301a. The lips 301c extend over the short height flanges 301b of the web-flange extension 301afe. The lips 301c have lip notches 126p where the lips 301c engage the flange 42b and lips 42c of the C channel also referred to as the metal framing member. FIG. 50 shows the shorter flange 301b at the web-flange extension 301afe. The extension cover 301ec is larger than the hole 36 and the extension cover 301ec also engage the flange notches 126fg, therefore the flange notches 126fg engages the reverse lip spacer brace 301 at the protrusion and engage the extension cover 301ec. The extension cover 301ec and the ledges of the lip have a fire protection coating 333 install between the web 42a of the C channel 42. FIGS. 33 & 46 show sloped flanges 302b, however if the flanges 301b were slanted inward on the overlapping reverse lip spacer braces 301 the smaller reverse lip spacer brace 301 would have a snug fit and would be difficult to remove. The same principle is a smaller and larger reverse lip spacer brace had bulges 301bg then the bulges would also make overlapping reverse lip spacer braces 301 more difficult to remove. FIG. 52 shows the three views of the reverse lip spacer brace 301 being installed between the two metal framing members where only the silhouette of the hole 36 at the C channel is shown.

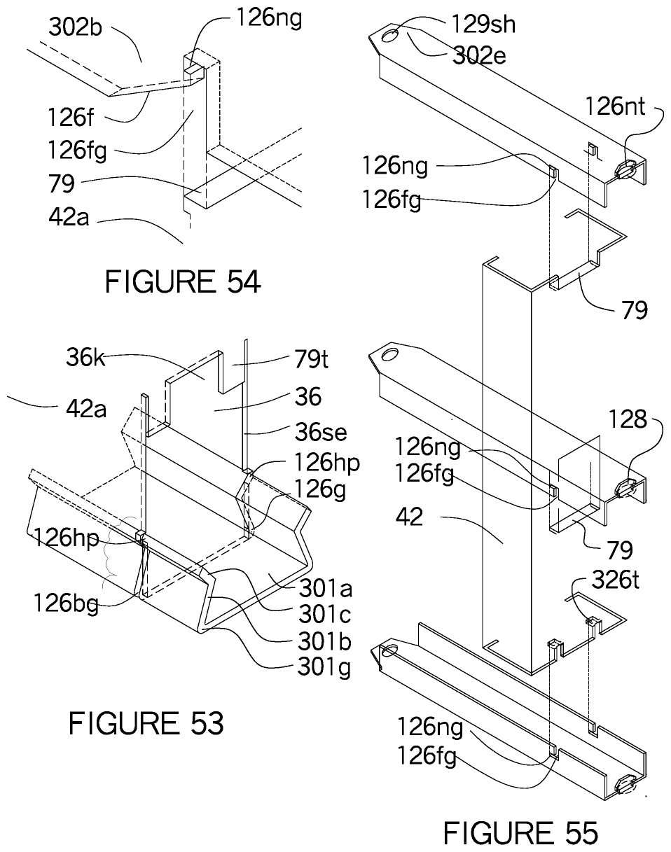

FIG. 53 show a reverse lip spacer brace 301 having a web 301a with bulges 301g on both sides having flanges 301b extending ventrally inward at an angle from the bulges 301g then bending outward forming a lip 301c. The reverse lip spacer brace 301 passes through the hole 36 so the bulge notches 126bg intersect the hole side edges 36se and the longitudinal side edges of the lips 301c are inserted into the hole lip notches 126hp forming a self-locking connection with the hole 36.

FIG. 54 also shows the shows the U shaped spacer brace 302 fitting into the hole 36 having the outside of the web 302a facing upward with the flanges 302b extending downward against the hole bottom edge 36be, The flanges 302b have flange notches 126fg that extend midway into the flanges 302b having a flare edge 126f on one edge when engaging the ledges 79. In FIG. 54 the flanges 302b with the flange notches 126fg extending from the hole bottom edge 36be having notches flanges 126ng at the blunt end for the ledge 79 engages the flanges notches 126fg securing the U shaped spacer brace 302 to the ledge 79 of the support member. When a fire shield connector is used the ledge 79 would extend to the underside of the web 302a or the flange notches 126fg will extend to the web 302a so eliminate the gap below the web 302a. In addition the lips 301c and double lips 301cc would be used to fill the void created by a fire chamber.

FIG. 55 shows the flanges 302b at the top, middle and bottom of U shaped spacer braces 302 with the flange notches 126fg. The flange gap 45fg and the flange notch 126fg at the flanges 302b make the connection into the crossing member. The top and middle spacer braces us the ledge 79 at the web 42a to form the ledge 79 and the middle U shaped spacer brace 302 is using the ledge at the hole bottom edge 36be to connect into the notches similar to ledges 79 used in the pending application U.S. Ser. No. 15/295,172. On the other hand, the tabs 326t of the punched out tabs 326 act as a ledge 79 when the tabs 326t fit into the L-shaped gap 45e and the tab 326t get inserted into the web notches 126w.

Many FIGS. are included in this application to show the different configurations for a fire shield connector can have as well as the different connections that can be used to produce a fire shield connector. The various configurations are not always showing a completed fire shield connector at the hole or when the lips extend throughout the wall cavity, but only showing the connection configuration at the hole of the metal framing member. There are many different combinations that can be included to form a fire shield connector, however the fire shield maybe U shaped spacer brace or a reverse lip spacer brace with the flanges and lips extending upward or downward. The fire shield can have lip notches, flange notches, web-flange notches, bulge notches, continuous flange notches. The notches can be crimped rather than a full notch, but both having the function of a notch. The reverse lip spacer brace or U shaped spacer channel can have bends or various shapes and still maintain the integrity of a fire shield connector. The extension cover 301ec can be on the same side as the spacer brace or the extension cover is on the opposing side where the extension cover has to be installed first. The extension cover can be loose as a flat plate or in combination as a bracket. The hook tongue with the receiver hole can be located in different positions still creating a fire shield connector separating fire chambers. The hook tongue can support other spacing-bracing members as well as flat plates and flat plates can close the hole in the metal framing member in various ways.

The present invention of the unique spacer braces are so versatile that the spacer brace allows for a much easier and quicker installation of metal framing walls, installing horizontal and diagonal lateral bracing or installing hold-down spacer bracing at floors, installing horizontal and diagonal braces between support members either between holes or at the flanges.

It is understood that the invention is not to be limited to the exact details of operation or structures shown and describing in the specification and drawings, since obvious modifications and equivalents will be readily apparent to those skilled in the art. The flexibility of the described invention is very versatile and can be used in many different types of building applications.

1. A structural framing fire protection system comprising a fire protection shield connector within a wall cavity connecting adjacent metal framing supports together at the aperture opening of the support members by:
a wall cavity having a first structural member and a second structural member substantially identical to said first structural member, each said structural members having a web and flanges, each said structural member having an aperture with notches defined by said connector perimeter extending through said respective webs, with said wall cavity defined by having fire protection boards connecting the outside planes of flanges of said first structural member and said second structural member leaving a wall cavity between said first structural member and said second structural member;
a metal framing connector having an undulating profile lying in a plane, said undulating plane having a top side and a bottom side with a longitudinal first side and a second side with a first end and a second end with said first side and said second side each having a side plane extending from the first side and said second side and where said first side plane has an attached longitudinal third side plane and the second side plane has an attached longitudinal fourth side plane and where said third side and said fourth side have indentations at the free edges of said third side and said fourth side at abut said flanges of said structural members and have cutouts for said lips from said structural members; having
a first end of said connector having an extension arm extending through said notches in said aperture of said first structural member with said second end having a receiver element to connect said extension arm with said second end of a substantially identical connector and with said web of said second end extends upward forming an extension cover over said aperture of said second structural member.

2. The fire protection shield connector according to claim 1 wherein said third side has a fifth side extending from the distal side edge and said fourth side has sixth side extending from the distal side edge with said fifth side and said sixth side overlapping said flanges of said first and second structural members.

3. The fire protection shield connector according to claim 2 wherein said fifth side and said sixth side are flush with said flanges of said first and second structural members.

4. The fire protection shield connector according to claim 1 wherein said extension cover is wider than said aperture being attached by said connector having flanges notches for said extension cover to fit into.

5. The fire protection shield connector according to claim 1 wherein said hook tongue extending from said connector as said first end of said web through said aperture for said hook tongue to engage an individual extension cover to close said opening from penetrations in said web of structural member.

6. The fire protection shield connector according to claim 1 wherein said connector has flange notches extending from the distal ends of said flanges engaging the said aperture at said first end and at said first structural member.

7. The fire protection shield connector according to claim 1 wherein the first end of said connector has lip flange notches to engage said first structural member.

8. The fire protection shield connector according to claim 1 wherein the first end of said connector has L-shaped flange notches with ledges at said aperture bottom edges to engage said L-shaped flange notches.

9. The fire protection shield connector according to claim 1 wherein the extension cover being a bracket with said extension cover extending perpendicular to said web of said bracket with said bracket having a first side wall and a second side wall extending from the free edges of said web with said web and said side walls overlaps said extension arms extending from said first end at said first structural member.

10. The fire protection shield connector according to claim 9 wherein the said bracket has bulges in said side walls at the intersection of said web and said flanges for said extension arms having said bulges to overlap said extension arms.

11. The fire protection shield connector according to claim 9 where the said bracket extends from said web, said flanges and said lips of first structural member with said first wall and said second wall plus said third wall and said fourth wall overlap said extension arms with where said web has said perpendicular extension cover overlap said aperture of said first structural member.
